(19) United States
(12) Patent Application Publication
(10) Pub. No.: US 2011/0202270 A1
(43) Pub. Date: Aug. 18, 2011

(54) Delivery of advertisments over broadcasts to receivers with upstream connection and the associated compensation models

(76) Inventors: Sridar G. Sharma, Milpitas, CA (US); Binuraj K. Ravindran, Cupertino, CA (US); Jonathan Eng, Saratoga, CA (US)

(21) Appl. No.: 12/930,130

(22) Filed: Dec. 28, 2010

Related U.S. Application Data
(60) Provisional application No. 61/337,366, filed on Feb. 3, 2010.

(51) Int. Cl. G06Q 30/00; H04W 84/02; H04L 27/04; G01C 21/00

(52) U.S. Cl. 701/201; 370/338; 375/295; 705/14.69; 705/14.58; 705/14.4

(57) ABSTRACT

A system to add metadata to downstream broadcasts to devices such as smart phones, MP3 music players, tablet computers, etc. equipped with receivers to receive said downstream broadcasts and a full time or part time upstream digital data communication path. The devices are controlled to display or playback advertisements, images etc. in the metadata, detect click events indicating interest by a user in something in the metadata and communicate that click event upstream over a full time or part time internet or an SMS data path connection. Upstream communications to implement user interest such as visit web pages, make a phone call, start an e-commerce transaction are implemented by the client devices. The Transmitters have structure to insert metadata in band or out of band with the broadcast program content and can be coupled to ad servers.

### CROSS REFERENCE TO RELATED APPLICATIONS

This utility patent application claims priority to a prior provisional patent application Ser. No. 61/337,366, filed Feb. 3, 2010.

### BACKGROUND OF THE INVENTION

The Digital Terrestrial Radio and television broadcasts, Direct Broadcast Satellite digital TV networks like DirecTV and Dish Network, any other digital broadcast infrastructures offers a very low cost way to reach a potentially large local target audience with digital content such as web pages, advertisements for products related to the subject of the broadcasts, supplementary information giving more detail about the subject of the broadcast, etc. Typically the only limitations are the aggregate bandwidth and the maximum transmission unit (MTU) size of the broadcast network's channels. However, the broadcast infrastructure, in general, does not provide a digital upstream channel for interactivity such as requesting more information about an advertisement, ordering books, songs, DVDs or services which are the subjects of broadcasts or for any other purpose. This problem is mitigated because a number of devices today such as Smart Phones, MP3 Players, Tablets etc. have internet connectivity.

A great advantage of a broadcast network infrastructure is that it is not affected by impact of scale as the audience grows in number. In other words, it works just as well for one viewer/listener or for 3 billion. Furthermore, the existing Digital Terrestrial (DVB-T Standard—a European Digital Video Broadcasting-Terrestial standard which is hereby incorporated by reference, T-DMB) and Satellite broadcast network standards (DVB-S and DVB-S2 which stand for Digital Video Broadcast-Satellite standard, which are hereby incorporated by reference as is the DVB-C or Digital Video Broadcast-Cable standard) are designed to transport a variety of content such as Audio, Video and Data, i.e. the type of content that can be transported is not restricted by the standards. The same is true for Digital Terrestrial Radio broadcasts such as HD Radio (In Band On Channel) or Digital Audio Broadcast (DAB/DAB+/DMB-A).

On these broadcast channels, the various content types are carried on one or more sub-channels. Sub-channels are referred to by different names in the different standards for example in HD Radio they are called multicast and AAS channels while in DAB (Digital Audio Broadcast) they are simply called sub-channels. Conceptually they are centered on the same principle. The aggregate bandwidth of a channel can be provisioned across the different sub-channels and consequentially the content type can be provisioned to various channels and sub-channels. The term “In-Band Transmission” as used herein means the content of the ad or supplementary digital data such as a web page is broadcast in the same sub-channel as the main audio or video broadcast. The term “Out of Band Transmission” or “out-of-band” as used herein means the broadcast of the ad or supplementary digital data is transmitted on a different sub-channel than the main audio or video transmission.

There is an opportunity to send digital data downstream with the Digital Terrestrial Radio broadcast or any other digital downstream broadcast (or even analog FM downstream broadcasts) which provides additional information, ads for services or products which may or may not be related to the broadcast subject etc. This provides an opportunity to send downstream with the broadcast any digital data which can be web pages, ads related to the broadcast, excerpts of books, video clips from movies, audio clips from songs, etc. Significantly, it provides an opportunity to send advertisements for products or services related to the broadcast subject. Since the broadcast may cause a listener or viewer to become interested in and seek more information or order a product related to the broadcast such as the song being played, a DVD of the movie or a book being reviewed or discussed, etc., there is a need to provide a mechanism and process not only to send digital data downstream but also to provide an upstream path to allow listeners or viewers to respond to the ads and for the advertisers to know how many listeners or viewers actually responded to their ads.

Traditional radio and TV advertisements are passive and have relied on a cost per impression (CPM) or listener advertisement model. Advertisements simply provide information about a product or service in hopes that the listener/viewer is enticed to independently go to a website or make a call. They don't provide an easy way of “closing the loop”. There is in the prior art a “pay per click” advertising model for advertising on the internet. In this model, advertisers pay the hosting websites who display their ads when their ad is clicked upon by a user indicating an interest by the user to know more about the advertised product or service. With search engines, advertisers typically bid on keyword phrases relevant to their target market. When a search uses that keyword, the search engine site gets paid by the advertiser. Content sites commonly charge a fixed charge per click rather than use a bidding system.

Lessons learned from online advertising have shown that advertisers will pay more for the Cost per Click (CPC) or Pay-Per-Click Models compared with the CPM model because of the direct results and feedback provided by the CPC model.

To date, as far as the inventors are aware, this pay-per-click model has not been used where the advertisements are sent over the broadcasting infrastructure and an upstream path is used to push back click events.

The opportunity to graft a pay-per-click advertising model onto the broadcast infrastructure is made possible because more and more devices are being built to have internet connectivity. For example, smart phones or even older feature phones provide an upstream digital channel at least by their text message (SMS) service in addition to phone voice. There is a first category of devices that usually have internet connectivity all the time (assuming there is cellular connectivity), such as smart phones and iPads™ and other tablets with 3G connectivity.

A second category of devices are ones that have internet connectivity only a part of the time, for example when there are within the range of a WiFi Network sometimes referred to as a “hot spot”. An example of this type device is an iPad™ and other tablets without 3G capability as well as MP3 Players with WiFi such as iPod Touch™ or the Microsoft Zune HD™.

A third category of devices are those that don't have any direct connection to the internet. Instead, these devices can communicate with servers on the internet only through an outside application running on a host computer which has an internet connection. This connectivity occurs only when a computer with an active internet connection is coupled to one of these third category devices. Devices in this third category would include most base MP3 players like the iPod™ NANO which does not have any network connectivity but can communicate with a Host PC or MAC computer via a USB or UART or iPod™ Connector interface and can download songs or videos or audio books from the internet through the computer's internet connection and its iTunes™ application program or other Host application programs. The connectivity provides charging and in addition allows Host applications to communicate/sync with the device. Such third category devices will be referred to as Class 3 devices in this document.

A fourth category devices (referred to herein as Class 4 devices) are devices which have SMS capability and even though they are not data enabled they have data capability because they are built with 2.5G or later chipsets and work on these networks. SMS or text messages are small digital packets of a maximum 140 characters in length which are sent upstream to a cell system's servers through a control channel used as part of the infrastructure of the cellular system's cellular voice phone call data channels. These packets can be sent on the internet through an internet connection of the cell system's servers. Though they don't allow the user to have a full internet data connection, the data connection can be provisioned selectively by the cell system operator to send back click events to servers on the internet so as to be able to derive pay-per-click revenue from advertisers.

For the various categories of devices described above, there is a plurality of internet connection methods for the various devices in the categories described above. These include 3G and 4G Cellular Networks for phones and iPads and other tablet computers based on Windows or Android and readers such as the Nook™ and Kindle™ readers, as well as WiFi and WiMax connections. These connectivity methods are characterized by the fact that they are typically used as “unicast networks”, meaning each user gets transmitted their own copy of the data. Unicast networks are very wasteful in terms of bandwidth (BW) when the same content needs to be transmitted to a large audience. A canonical example would be where a provider wants to send ten 5 second audio clips to 100,000 subscribers encoded using a typical method of 48 kbps sample rate AACv2 encoding (AAC version 2 is a digital data compression standard). If this 5 second audio clip was sent as unicast packets, the bandwidth required on the internet would be over 2.4×10⁵ Mbits (megabits). The same content, if sent over a broadcast network, would only consume around 2.4 Mbits of the bandwidth.

Another canonical example would transmission of ten 200×200 PNG images (a photographic image standard). Assuming the size of each image is 12.5 KB then the bandwidth consumed when sent as unicast packets is 1×10⁵ Mbits. The bandwidth consumed when broadcast is 1 Mbits.

The broadcast transmission mechanism, as can be seen from the canonical examples above, is a very efficient method of pushing high demand content from the content provider to a large number of end consumers. Even more compelling benefits appear when the unicast connection methods mentioned above are augmented with an in-band or out-of-band digital data downstream channel as part of an broadcast connection, such as those defined by the terrestrial and satellite TV and radio standards such as HD Radio and DAB.

In general broadcast networks augmented with an in-band or out-of-band digital data downstream channel are perfect for delivering advertisement bearing and/or sponsored bulk data to a multitude of receiver devices. Examples of such devices are Smart Phones, Tablet PCs (e.g., Apple iPad™), Laptops with Digital TV and/or Radio receiver chips built in and/or an iTunes™ application, Netbooks with receiver chips built in and/or an iTunes™ application, Desktop Computers with receiver chips built in and/or an iTunes™ application, eReaders, etc. Good examples of content that can be transported as bulk data on the digital downstream channel which is in-band or out of band with the audio or video broadcast content are web pages, bestselling books, daily newspapers, magazines, top audio/video clips, event promotions, coupons or any other data which is intended for a wide audience and where it is wasteful to deliver this content as unicast packets. Additionally, by innovatively defining the delivery in combination with other device features results in many creative and new applications and solutions that are addressed in this document. For example, ads relevant to a subscribers current interests as derived from data mining at the server side or at client. As an example, applications that monitor what the subscriber's search request can be inserted by a client application on the device from which the searches were launched.

### BRIEF DESCRIPTION OF THE DRAWINGS

FIG. 1 is a high level functional diagram showing the basic architecture and flow of information in a system employing a basic embodiment of the apparatus and process.

FIG. 2 is a flow diagram representing the genus of process species which fall within the teachings of most if not all the embodiments disclosed herein.

FIG. 3 is a more detailed block diagram of typical device circuitry of a device which is capable of receiving downstream digital data broadcast programs and the digital metadata transmitted on the subchannel and which has circuitry and software to communicate click events and web server requests upstream.

FIG. 4 is a diagram of a typical software architecture of a device which can implement a process within the genus of FIG. 2.

FIG. 5 is a flowchart of a typical processing flow by client device software including the “client application” which handles metadata processing.

FIG. 6 is a block diagram of the broadcaster block 100 in FIG. 1 if the downstream broadcast is a Digital Audio Broadcast (DAB).

FIG. 7 is a diagram of the transmission frame for a DAB broadcast. A DAB multiplexed transmission stream can carry audio and multimedia data and the metadata either in band or out of band.

FIGS. 7(A) and 7(B) shows how start and end transition markers for ads can be inserted into extended header fields of each audio packet in IBOC. It also illustrates how to splice an alternate advertisement into the IBOC Main and Secondary Program Streams

FIG. 8 is a block diagram of a DAB broadcast transmitter giving more detail about the functions within the blocks of FIG. 6.

FIG. 9 is a block diagram of an HD radio broadcast station as an example of what block 100 in FIG. 1 would be if it were an HD radio broadcast station. The metadata is sent downstream in band as AAS data.

FIG. 10 is a diagram of the different OSI layer 2 PDU possibilities meaning the different layer 2 frames possibilities of Main Program Stream (MPS), Supplementary Program Stream (SPS) and AAS data that can be broadcast on the digital data modulated carrier of the HD broadcast.

FIG. 11 is a diagram of the IBOC radio audio frame format showing how metadata can be stored in PSD field and how pointers or transition point data for ad insertion can be stored in the extended header.

FIG. 12 is diagram of an AD-ID data structure that is one way of doing time slicing. Layer 1 frames in IBOC can be associated with such AD-ID data structures.

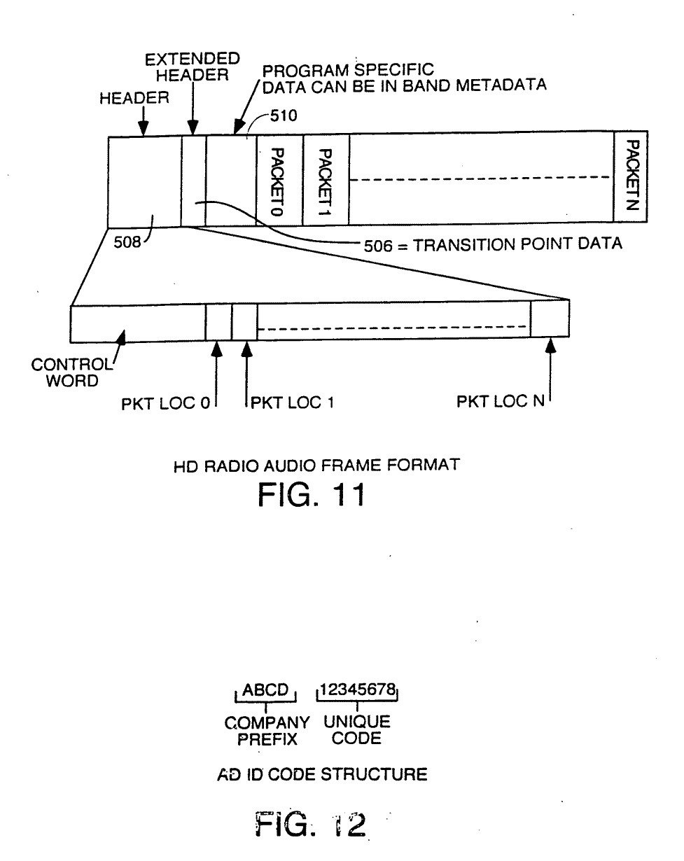

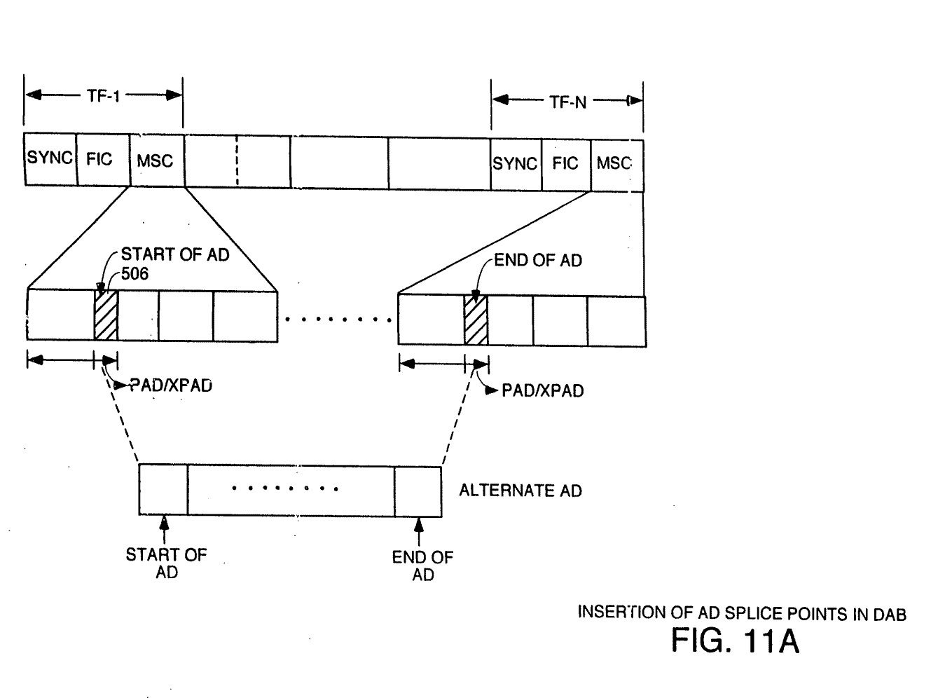

FIG. 11(A) shows how the start and end transition markers for ads are inserted into DAB PAD/XPAD fields 506. It also illustrates how the slicing of an advertisement to a DAB sub channel can be accomplished.

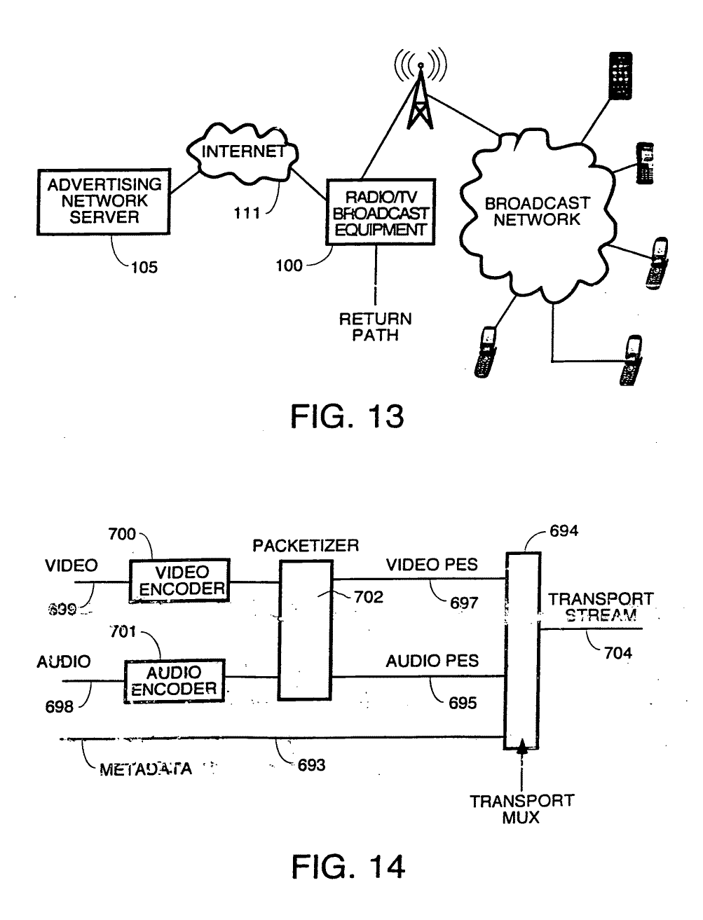

FIG. 12 is a diagram of a AD ID code structure.

FIG. 13 is a diagram of a system in which an advertising network server does its work to send ads for broadcast to Radio/TV broadcast equipment via the internet.

FIG. 14 is block diagram of a typical circuit portion of a broadcast transmitter that generates an MPEG transport stream.

### DETAILED DESCRIPTION OF THE PREFERRED EMBODIMENT

There are multiple points of novelty in the innovations described herein which are described in separate sections below.

### Basic Idea: Compensation Per Click Ad Delivery Model Applied to Broadcasts

The innovations described in this document apply to all four classes of devices described in the Background section. In the case of Class 2 and 3 devices when they are not connected to the internet the data to be sent upstream is cached on the device and pushed upstream to the appropriate pay-per-click servers or other web servers such as Amazon™, iTunes Store™, Netflix™ when there is connectivity of the device to the internet by any channel.

This section describes an innovative way of bringing the Compensation Per Click (CPC) advertisement model to broadcasts to Category 1 through 4 devices which have some sort of full time or part time digital upstream data path and which have broadcast receivers in them or which are modified to have broadcast receivers in them. In particular, most of the embodiments employing the teachings of the invention will have receivers in them which are capable of receiving digital broadcasts of audio and/or video broadcast programs or podcasts (digital files of audio programs which are broadcast). Most of the embodiments use the terrestrial, cable, satellite or fiber optic network broadcast infrastructure as the downstream connection and using any one of a number of different digital upstream connection methods to send click events and other digital data carrying out communications to implement the type of interest expressed by the user, e.g., buy a product, visit a website to get more information, initiate a phone call etc. The digital upstream connections to send these click events and other interest-based communications include: cellular data channels via Wireless Access Protocol (WAP), SMS, WiFi, WiMax, direct internet connection via a router, etc.

In general this methodology can be applied to any device that can receive a broadcast signal with a digital subchannel in it for transmission of metadata and which has a way of communicating digital data back upstream such as the internet, connected host PC or SMS. Examples of downstream broadcasts where the invention can be employed are: HD radio, Digital Audio Broadcast (DAB) digital terrestrial TV, DBS satellite digital (DirecTV, Dish Network), Digital Video Broadcasts to handheld devices DVB-H, or even analog FM radio broadcasts using the RDS digital channel for transmitting limited amounts of metadata, etc. Most embodiments where useful amounts of metadata can be sent use digital downstream broadcasts.

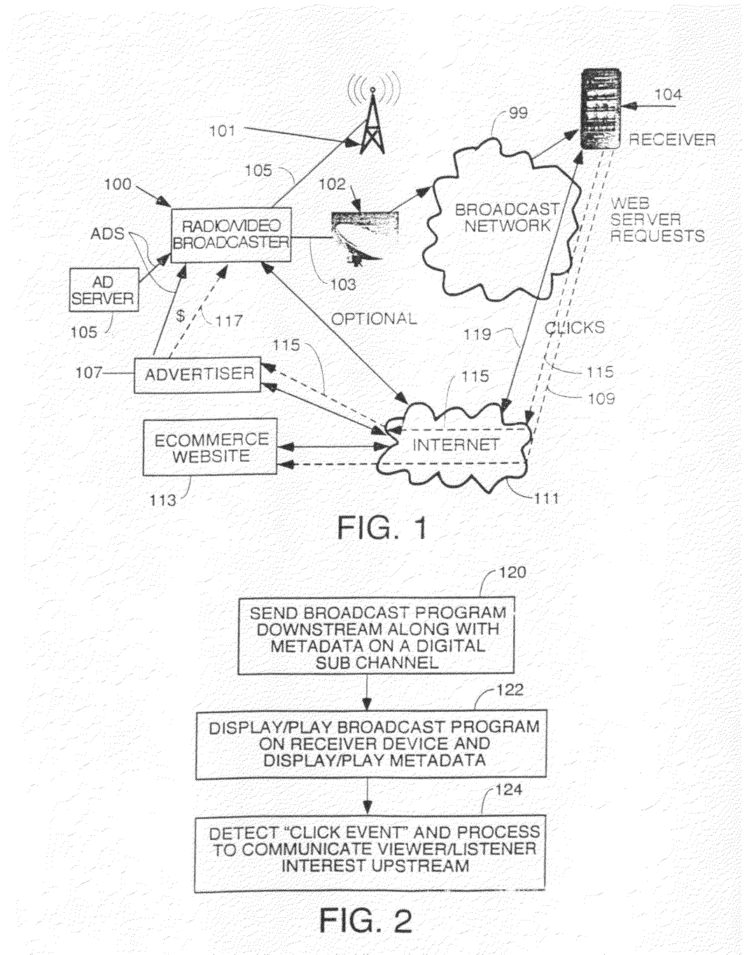

FIG. 1 is a high level functional diagram showing the basic architecture and flow of information in a system employing a basic embodiment of the apparatus and process. Existing audio and video broadcast content or advertisement content that is broadcast today (either over radio frequency channels according to the various audio and video terrestrial, satellite and cable standards) can be augmented with metadata transmitted on a digital sub channel and intended to be displayed on the screen of the device having the receiver receiving the broadcast. This metadata can be any digital data such as web pages, advertisements, images, video clips, coupons, etc. and maybe related to the broadcast subject matter, but need not always be related. Broadcasters can derive revenue if a viewer of the broadcast seems something in the metadata that interests him or her and clicks on it and that “click event” is sent upstream.

The basic genus of processes that is carried out by systems identical to FIG. 1 or adaptations or modifications thereof is shown in the flowchart of FIG. 2. There is a plethora of variations or species of the basic process shown in FIG. 2, but they are, for the most part, all within the basic genus defined by the three steps of FIG. 2. Step 120 represents the process of sending any broadcast program downstream in any way audience of viewers/listeners having receivers. The receivers must be capable of receiving, decoding (if necessary), de-multiplexing (if necessary) and displaying or playing the audio or video broadcast program and receiving, decoding, de-multiplexing and displaying or playing the metadata concurrently with the primary audio or video content. The metadata is any kind of digital data is used to augment the broadcast program. When displayed or played with the primary audio or video content or at any other time, could generate interest in a viewer who sees it or hears it either while watching or listening to the broadcast program or at some other time. The metadata is modulated in any way onto any type digital sub channel that is either within the bandwidth of the broadcast program (in-band) or in a portion of the downstream transmission that is outside the bandwidth of the broadcast program (out of band) i.e. in a different sub-channel. Step 122 represents the process of displaying and/or playing the downstream broadcast program and displaying and/or playing the metadata either along with the broadcast or at some other time. Step 124 represents any process for detecting in any way any type of click event indicating any form of interest such as a request for more information, a request to buy a product or service, a request to make a call or visit a website, etc. After detecting the “click event”, the “click event” is processed in any way to do whatever the viewer/listener requested and to send a “click event” notification upstream. The “click event” is sent upstream to an advertiser, broadcaster or any other collector of such events using the internet connectivity and/or phone circuitry and software of the device containing the receiver which received the broadcast. In some embodiments, the “click event” and other upstream communications to carry out the indication of interest are sent via a personal computer. The personal computer is connected to the device containing the receiver which received the broadcast and the click event is sent via the internet connectivity (wired or wireless) of the personal computer. The internet connectivity and/or phone connection used to send upstream “click events” and other data communications upstream needed to carry out the interest of the viewer/listener not be carried out immediately. Such upstream communications and “click events” can be sent upstream later when internet connectivity and/or cellular phone/data path coverage is available. These delayed upstream communications are carried out using cached “event click” information and other cached data needed to carry out the interest request such as URLs and standard requests for web services, or cached phone numbers.

The hardware and software used to carry out the genus of processes represented by FIG. 2 include the collection of equipment that is used to broadcast at a radio or TV broadcaster, and is represented by block 100 in FIG. 1. Analog audio or video programs or digital files can be input to the broadcast equipment 100. Basically, whatever format the broadcast program is in, it will be digitized, compressed, and modulated onto an RF or light wave carrier using any digital standard. The downstream broadcast carrier can be a radio frequency (RF) carrier if the broadcast medium is radio waves or microwaves or satellite or light waves if the broadcast medium is a fiber optic network such as the Uverse™ broadcasts over the AT&T fiber optic network. Analog audio or video programs will be digitized and packetized into frames and encoded to compress using the MPEG2, AAC, H.264, MPEG1 or MP3 compression standards. For example, audio programs will be digitized into Pulse Code Modulation (PCM) stream format which are then put into frames. Compression of PCM stream and digital files of broadcast programs or other format digital data derived from audio programs. In some embodiments, the transmitter includes circuitry to transmit Table of Contents data downstream either in the metadata or as part of the broadcast program stream. The Table of Contents data, in some embodiments, includes any combination of the following items of data about each advertisement and/or program broadcast in the main program stream and/or the metadata: the subject, language, time of broadcast; duration; and/or a unique advertisement code from which information about the ad can be inferred such as the subject, location of stores which sell the product or service which is the subject of the ad, etc. In some embodiments, the transmitter includes circuitry to transmit a unique code with each ad and/or each program broadcast and to keep a record of these codes for later transmission to an entity which compensates the broadcaster for broadcasting ads or to pay royalties on royalty bearing works which were broadcast.

The downstream signal to be broadcast is represented by lines 103 and 101 to a satellite dish 102 and a terrestrial broadcast antenna 101, respectively. Not shown are downstream signals to be broadcast to a cable system headend or a fiber optic network like the Uverse network or an HD radio broadcast antenna (usually the same antenna that broadcasts the AM or FM radio station signal). These downstream signals carry both the metadata some of which can be used to generate “click events” and the broadcast content (audio and/or video and/or podcast files).

In some embodiments, the metadata to be transmitted is transmitted with the broadcast content in a sub-channel within the band of the broadcast content (referred to an in-band transmission). In other embodiments, the metadata is transmitted out-of-band, i.e., the ad or supplementary digital metadata is transmitted on a different sub-channel than the main audio or video transmission. In most embodiments, the broadcast is carried out using some Digital Terrestrial Radio Broadcast standard format which is conducive to sending metadata in a digital subchannel which is either in-band or out-of-band.

The metadata can be collected by the broadcast equipment 100 from ad server networks 105 via the internet or the metadata can be supplied directly to the broadcast station by advertisers 107 or other providers. An exemplary list of metadata associated with an advertisement or a broadcast program would be: short audio/video clips; images; web content such as a web page containing information relevant to or supplementing the content of the broadcast or ad (such as a picture of an album cover, review of a book or DVD, biography of the artist singing the song being broadcast, etc.); name of a seller of products being shown or described in a broadcast; URL of a server where a book, song or DVD or other product or service being shown or discussed in the broadcast can be purchased; and/or contact phone number of an entity that sells a product or service being shown or discussed or who has more information about a topic.

The main broadcast content and the metadata are received by Category 1 through 4 devices, represented by device 104. Each of these types of devices has receiver circuitry for receiving terrestrial or satellite cable RF broadcasts or Uverse™ downstream digital broadcasts on light waves, and has a display on which the broadcast and metadata can be displayed and/or an audio transducer on which the broadcast and/or metadata can be played. The receiver circuitry demodulates, decodes, error corrects, demultiplexes and decompresses the digital data of the broadcast and metadata subchannel as necessary per the standard being used for the broadcast. The main broadcast content is played or displayed by the Category 1-4 device and the metadata is also displayed or played either simultaneously with the broadcast in any manner. For example, the metadata may be displayed in a separate window and a broadcast is being played or viewed or displayed in a rolling scrollbar bar somewhere on the screen of the device. Or a broadcast program can be interrupted on the display from time to time to display metadata ads, images, video clips etc.

The metadata may stir interest in a viewer or listener in a product or service which may stir the listener or viewer to want to buy, get more information, visit a website, call somebody, or do something else indicating interest. The Category 1-4 device being used to receive the broadcast executes a client device program which provides a way for the user to, for example, use an upstream connection 109 and the internet 111 to carry out upstream communications to buy a product from an e-commerce server 113, visit a website, initiate a phone call, etc. Standard web service request protocol communications travel upstream over data paths 109 and 111 to, for example, order a product being displayed or discussed on the broadcast or obtain more information about a product/service or topic mentioned or discussed or displayed in the broadcast.

In some embodiments, a broadcast enabled client application computer program (not separately shown), hereafter referred to as the “client application” running on the Category 1-4 device 104 provides the user with an upstream data channel and an easy method for initiating a “CPC like event” also referred to herein as a “click event” which is communicated upstream via any data path 115 to an advertiser 107. The advertiser then pays the broadcaster or whoever else in the food chain to whom payments are due or helpful based upon the “click event” data, as represented by line 117. Compensation for click events can be based upon any model such as simply the number of click events which occurred or the type of click events that occurred or any other criteria or any combination of criteria. A “CPC like event” or “click event” could be, for example, an indication of interest, a request for more information or a request to buy a product or service or a request to initiate a phone call. The client application controls the Category 1-4 device by displaying a link, i.e., a URL of a webpage, to click or displaying a “buy” or “call” or “more info” button which, when selected by the user of the device, initiates a buy order or starts a phone call or initiates an inquiry for more information to an entity who sells a product or service or which can provide more information. This upstream “click event” or “CPC like event” (indication of interest in any way) is either sent immediately on digital upstream data path 115 if upstream connectivity is available at the time the click event occurs, or later when upstream connectivity is established. The upstream data path 115 is digital and could be the device's internet connection or the SMS data path of a cell phone including either a smart phone or a feature phone.

The digital upstream data paths and return data paths are represented in FIG. 1 by the bidirectional arrow 119 between the device 104 and the internet cloud 111. The types of information that can travel on data path 119 or any other data path is represented by data paths 115 and 109.

The “click events” could be sent upstream on data path 115 instantaneously if the Category 1-4 device is currently connected to the internet or is connected to the internet through the data path and Wireless Access Protocol (WAP) connecting the cellular digital data path a cellular network to the internet or via a sync or charging connection to a personal computer coupled to the internet. If the Category 1-4 device does not have a currently active internet connection or SMS connection, the click event can be stored in memory and sent upstream at a later point in time when the device is connected to a network such as when a hot spot is encountered or the device is coupled for sync or charging to a computer with an active internet connection.

The internet cloud 113 is connected to e-commerce servers 113 and other servers (not shown) which provide more information on topics and to servers which collect click event data and report it to advertisers and/or broadcasters.

The click events can also be sent upstream via the cellular provider SMS data path (not shown) and internet cloud 111.

In addition to providing the end user with a way of communicating easily with the seller, measureable metrics can also be obtained about the user and/or his preferences. Since the end user is now directly indicating interest in the advertised service or product, broadcasters can now have access to metrics that can be used to measure the effectiveness of the advertisement. When the user clicks on the ad or impression or initiates a call, metric data about the broadcaster, user and/or advertiser information can be stored in the device and later or instantaneously collected by an advertiser via the upstream data path and/or sent as part of the click event to a web server conducting e-commerce which can store it for collection later or send it via any data path to the advertiser or other entity interested in collecting information of that sort such as a ratings service. Collecting this information from the device or from e-commerce or other servers contacted by the click event through the connected network will provide valuable information that can be used by broadcasters for billing advertisers, by broadcasters or advertisers for tracking user preferences and by broadcasters or ad server networks or advertisers for showing broadcast advertisement effectiveness and selecting ads to send to the broadcaster.

Since the end user is provided with an easy and convenient way of communicating back to the seller, as is possible with online advertisements, the cost per click (CPC) model can be extended to the world of broadcast advertisements. That is one of the basic processes described herein. Beyond the direct CPC initiate customer contact, the click could alternatively reference additional broadcast content that is being sent or has been sent and currently cached on the Category 1-4 device. In Class 2 and Class 3 devices, OOB advertisements can be downloaded into the device and pre-cached when connected to the internet. This cache would augment the broadcast content. In a class 1 device, advertisements could be downloaded and cached when the device is connected to a cheap (non-cellular) network.

For example, a longer more detailed video advertisement has been downloaded to the device using an out of band (OOB) broadcast channel. When an event on the main content channel occurs, such as a short ad, the user can be informed of the longer ad's existence and prompted to play it. Even if this content does not yet exist on the device, it could still be downloaded through the unicast network. Accessing the additional content also indicates user's interest and can be deemed a click.

A further extension to this advertising model would be to save the last few advertisements so that they can be perused by the device user at a later point of time. The advertisements received over the air would be automatically stored on the receiving device. The in-band audio/video advertisement is combined with the metadata (both in-band and out-of-band—additional innovations regarding OOB will be discussed later) and stored in a RAM, hard disk or any other memory of said device, hereafter sometimes simply referred to as cache This can be accomplished by splicing out the audio/video corresponding to the advertisement from the stream. The metadata transitions are used to determine splice points unless the splice points are part of the broadcast. As an example, to extract the in-band audio advertisement, splicing out the audio corresponding to the advertisement from the main audio stream using transitions in the Program Specific Data (PSD) field is necessary.

The end user can later peruse the metadata associated with an advertisement cache. The end user of the device will be provided the ability to tag advertisements that interests them. This tagged information could serve as a reminder to the user (note feature) or it could also be used to get additional information in a connected device (“a connected device” refers to a device with an always on internet connection or a device which has internet connectivity only when in a hot spot or when coupled to a PC for sync and the PC has an active internet connection). The advantage is that the user would get additional information about advertisements that they care about and the advertiser is happy that the advertisement has reached a targeted audience. Tagging or viewing of the ad later is a convenience for the user and it also constitutes a click event which is communicated upstream to a user, broadcaster, etc.

### A More Detailed Look at the Process

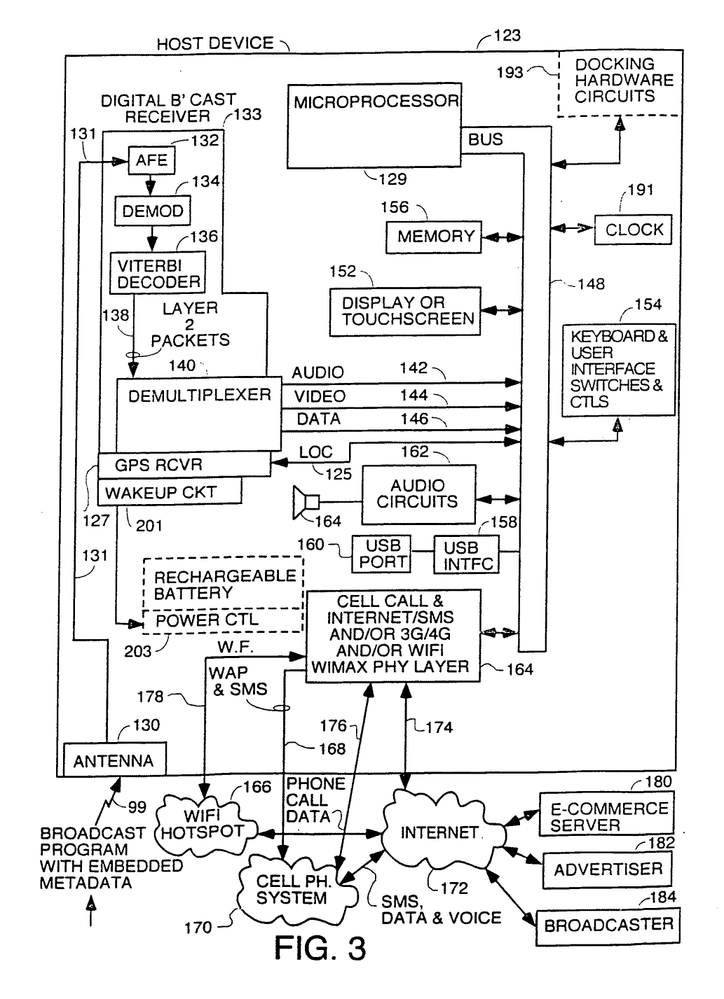

FIG. 3 is a more detailed block diagram of typical device circuitry of a device which is capable of receiving downstream digital data broadcast programs and the digital metadata transmitted on the subchannel and which has circuitry and software to communicate click events and web server requests upstream. The broadcast programs data modulated onto an RF carrier and metadata included therewith in a digital downstream subchannel enters from the medium of the broadcast network 99 and is picked up by the broadcast medium physical layer 130 which is illustrated as an antenna but which may also be a cable modem or modem for a fiber optic network. The signal received by the physical layer circuitry 130 is transmitted on line 131 to a receiver 133. Shown is a digital broadcast receiver since most embodiments employ digital broadcast as the downstream, but the invention can be applied in analog broadcasts if the analog broadcast signal can be modified to embody a digital downstream subchannel or already has a digital downstream subchannel. Examples of this would be Digital subcarrier added to Analog FM referred to in the claims as FM+RBDS/RDS. This is equally applicable to a protocol which uses any digital FM subcarrier system. The details of the receiver depend upon the particular broadcasting standard being used, and the illustrated receiver is typical for digital broadcast standards such as DAB or ATSC, or Mobile ATSC or DVB or any data broadcast protocol or standard developed in the future. Most embodiments of processes and apparatus within the scope of the invention employ category 1 through 4 devices with a digital broadcast receiver 133 such as an HD radio (IBOC) or DAB radio receiver to receive broadcasts which includes a digital subchannel for the metadata. The digital broadcast receivers typically are able to separate out the audio data frames, video data frames, image data and other digital data which was broadcast including the metadata. The various forms of data are provided to a microprocessor 129 which is the main computer of the device.

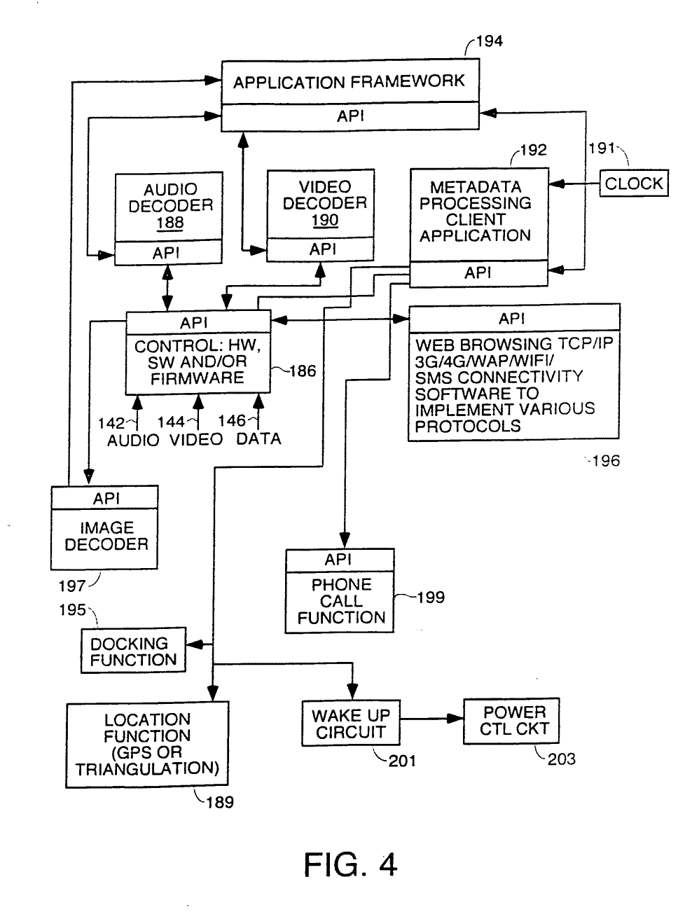

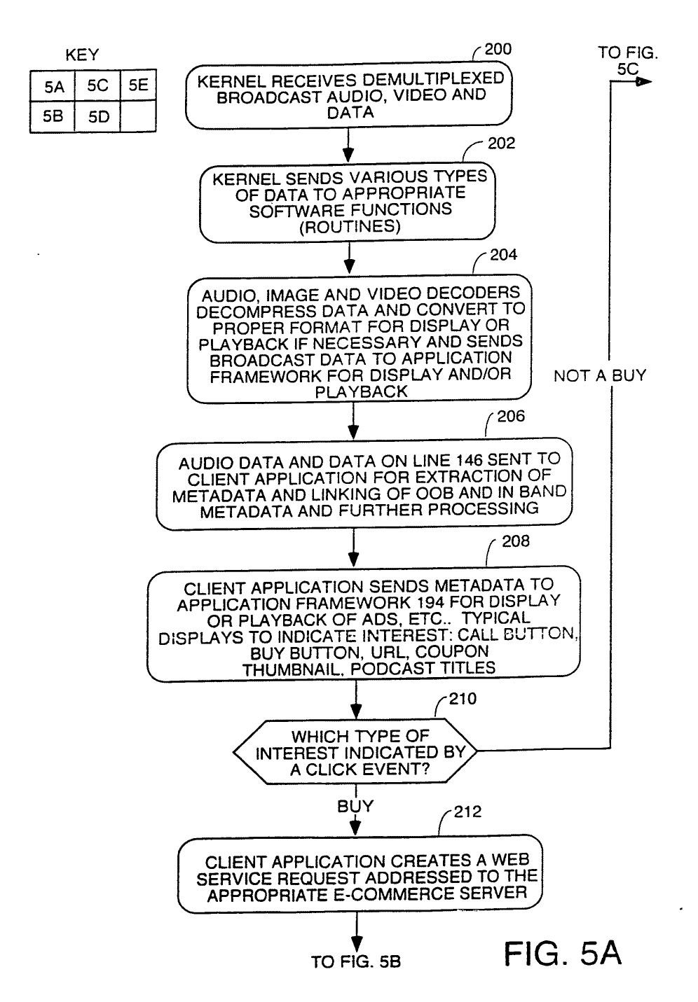

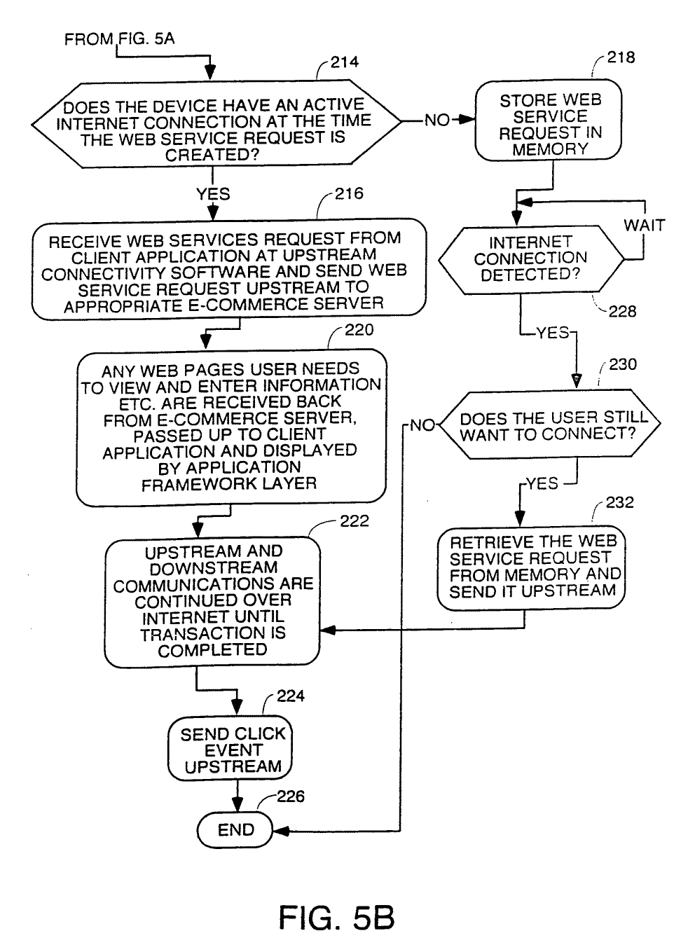

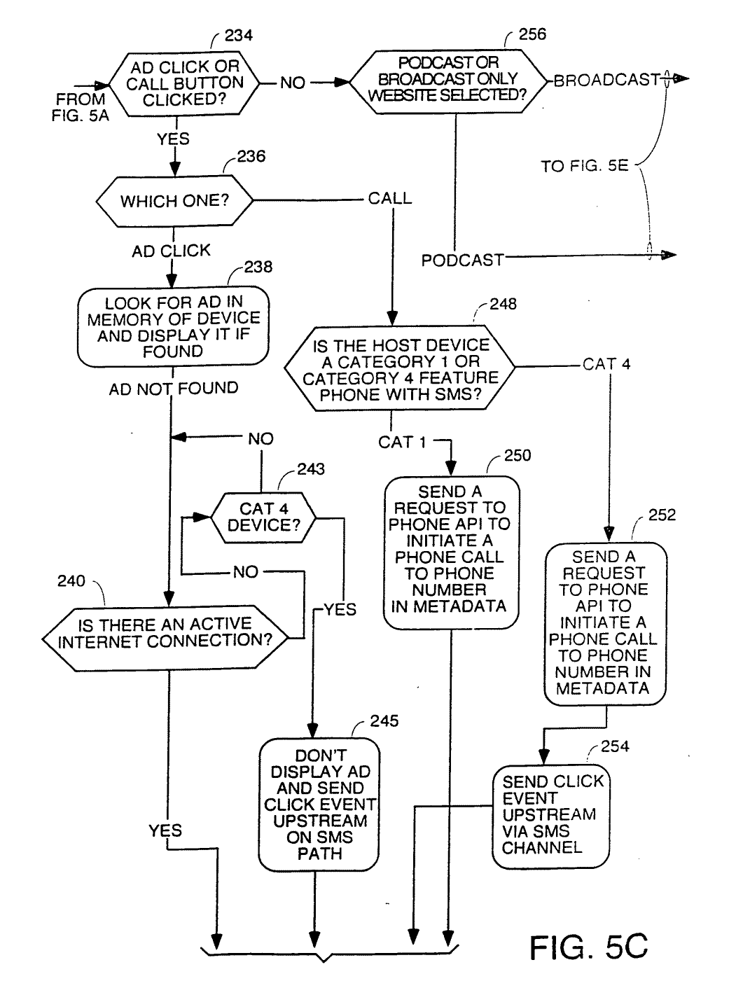

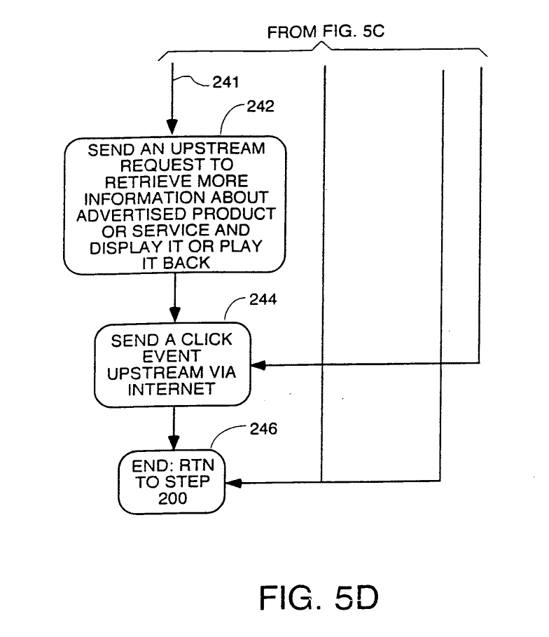

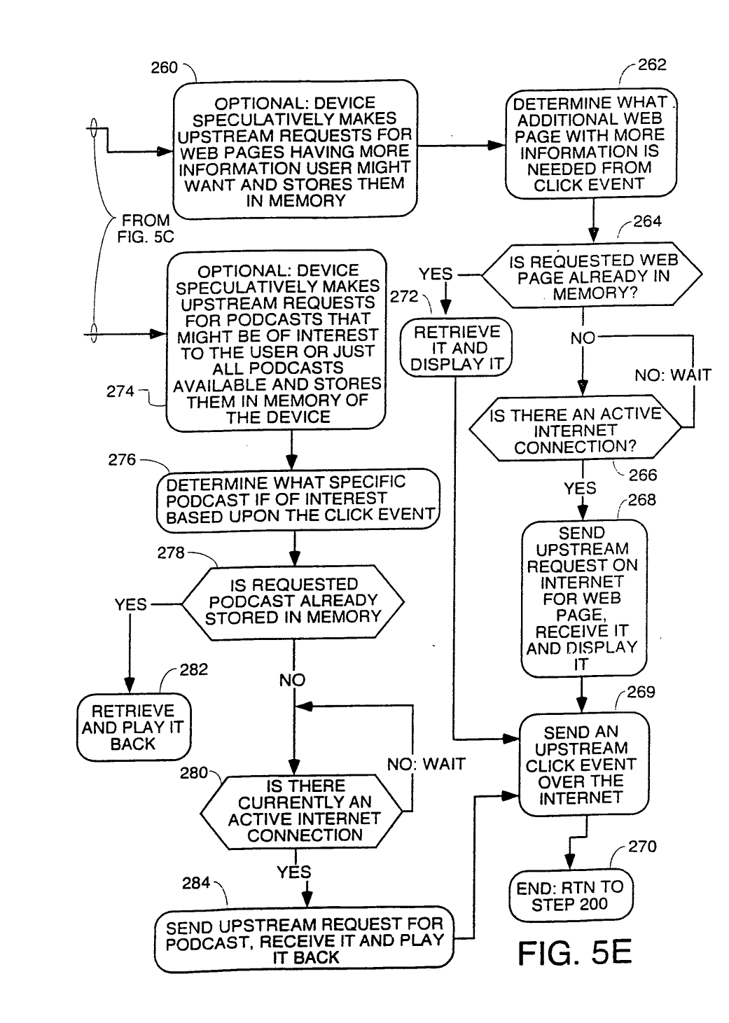

The microprocessor 129 functions under control of the various software layers to be described next to carry out all the functions of the device including the metadata processing. The metadata processing is carried out by a “client application” 192 in FIG. 4 and will be described more fully in connection with discussion of the software architecture diagram of FIG. 4 and the detailed flowchart of processing by the client application of FIG. 5.

An exemplary block diagram of receiver 133 is given here, but the functional blocks may be different depending upon the broadcast medium used, the digital broadcast standard used, the type of compression used and the type of transport protocol used. An analog front end tuner (AFE) 132 tunes to the user selected channel carrying the broadcast the user wishes to view and/or listen to. This tuner typically amplifies and filters the signal to put it in condition for demodulation.

A demodulator 134 demodulates the digital date modulated onto the carrier and its structure will depend upon the modulation scheme used, e.g., QPSK, OFDM, DQPSK, etc. The demodulator provides its output to a Viterbi decoder 136 which functions to recover the layer 2 digital data packets in the transport stream. Most Video Broadcast TV standards use the MPEG transport stream which have MPEG2 or MPEG4 encoded packets. MPEG transport streams are designed to carry compressed digitized video and digitized audio signals over lossy mediums. The Viterbi decoder does error detection and correction using error correction bits added to the stream.

The output stream of packets of the transport stream on line 138 are sent to a demultiplexer 140 which separates out the audio data, video data and other data onto lines 142, 144 and 146, respectively. The data on line 146 include out of band metadata. Separate sections below detail the transmission formats and equipment used in DAB and IBOC (HD Radio) downstream broadcasts, both of which are specific examples and embodiments within the genus being described here. To avoid losing the reader in a mass of detail unnecessary to understanding the basic idea, those sections are not included here.

In the case of Digital Audio Broadcast the in band metadata is usually transmitted in the Program Associated Data (PAD) bits which are part of every 24 millisecond audio subchannel frame. The PAD metadata bits sometimes function as a pointer to out of band metadata transmitted on another sub channel.

Baseband processing, Layer 2 Processing and Host processing can be done by any combination or hardware and/or software and there are many different possible combinations. The specific example given here is only one of the possibilities. It is the intent of the appended genus claims to cover all these different possibilities.

The audio, video and other data on lines 142, 144 and 146 (everything done by blocks 134, 136 and 140 can be done in software so lines 142, 144 and 146 may only be symbolic data paths to the software and microprocessor) are coupled to the microprocessor 129 by bus 148. This bus couples the microprocessor to all the circuitry in the device which needs to receive data from or exchange data with the processor 129. The processor 129 uses the bus 148 to drive a display interface and display 152 and receives data therefrom if the display is a touchscreen. The bus also couples the processor 129 to a keyboard 154 if the display is not a touchscreen. The keyboard 154 also represents other switches and controls of the user interface of the device such as power switch, volume control, pointing device, etc. Memory 156 is coupled to the bus 148 as is a USB port interface 158 to a USB port 160. Memory 156 can be any type of nonvolatile or volatile memory with battery backup that can store data and recall it when needed regardless of power down of host device including hard disk, RAM, ROM, EPROM, EEPROM, etc. Audio circuits 162 couple the processor 129 to a speaker and/or headphone output 164 to play audio portions of broadcast programs and/or metadata.

Physical layer circuits (PHY layer) for the internet and/or an SMS channel and/or cellular 3G or 4G (or lower or higher) protocol connectivity to the internet via a cellular system data path are represented by block 164. The SMS data path is typically a subchannel where short data packets can be sent on the control channel of a cell phones voice data path. The SMS channel may be the only digital data upstream path on devices like feature phones (non “smartphones”) and also exists on smart phones and, via downloadable apps, on devices like iPads™ either with 3G connectivity or only part time connectivity to the internet through wifi hotspots such as 166. Upstream connectivity to the internet for devices with always on data connectivity such as smart phones with data plans, iPads with 3G connectivity circuitry and software and data plans to implement an always on connection to the internet is represented by block 164 (which includes an RF transceiver) and wireless data path 168. Wireless data path 168 represents both Wireless Application Protocol (WAP) data connections to cell phone system 170 for wireless connection to the internet 172 and the bidirectional SMS data path subchannel on the control channel of the cell systems voice data path for phone calls. Those skilled in the art understand how the WAP protocol hardware and software work so further detail is omitted here.

Block 164 also represents WIFI Physical Layer (PHY) circuitry including an RF transceiver and the appropriate drivers or software libraries to implement the WIFI protocol which is a superset of the IEEE 802.11 standard. All standards mentioned in this specification are hereby incorporated by reference.

The device may also have a LAN connection or direct connection to the internet through an ethernet connection to a router or a direct connection to the internet through a switch/router/server with routing functionality and modem, all as represented by line 174.

Upstream communication of click events occur over the internet or SMS channels, and upstream and downstream internet communications to carry out user e-commerce requests, requests for more information and to initiate phone calls all involve the “client application” and other software layers in the device, the PHY layer circuitry 164 and the data paths 178 or 168 or 176 or 174, the hot spot 166, the cell phone voice and/or data paths and the routers in the cell system which route SMS, phone call data, metadata and other data to the internet 72, the internet 172 and various servers coupled to the internet such as e-commerce server 180, advertiser server 182 and broadcaster server 184.

FIG. 4 is a diagram of a typical software architecture of a receiver which can implement a process within the genus of FIG. 2. The receiver can be implemented on a single chip or a collection of chips. Components of the receiver can be implemented in hardware, software or any combination thereof. The operating system 186, called a “kernel” for short for lack of a better term. All references to the “kernel” herein or in the drawings should be understood to mean any combination of hardware, firmware and/or software which manages all applications and circuitry of the device and manages memory and performs some or even most of the functions described herein necessary to implement the teachings of the invention at the client device. The receiver receives the broadcast audio and video data and other data including OOB metadata on data paths 142, 144 and 146, respectively.

Audio data is sent to audio decoder process 188 where it is decompressed and sent to the audio circuitry 162 for play.

Video data is sent to video decoder process 190 for decompression and conversion to an appropriate format for display and is sent to application framework 194 for display.

OOB metadata and audio data (for extraction of in band metadata in the PAD bits is sent by the receiver firmware (usually but this function can be done by any combination of hardware, software and/or firmware) to metadata processing client application 192 for extraction of the in band metadata, linking of the OOB and in band metadata, processing of click events and implementing upstream communications to carry out the user's indicated interest.

An image decoder function 197 is sent image data (as an example in PNG and JPEG format) received by the receiver in the data on line 146 and decompresses it and puts it in a format suitable for display and sends it to the application framework 194.

A phone call function 199 controls the device's phone call circuitry to initiate and receive phone calls over a cellular network (or Skype™ or other voice over IP functions such as Google Voice™).

The application framework 194 provides the software functionality to drive the display, receive click events and other user input data from the keyboard, touchscreen or pointing device, provide menus and browsing windows and other windows and other basic functionality of the device.

Block 196 represents multiple software processes/layers to implement: 1) web browsing software to implement the TCP/IP protocol and communicate with the appropriate PHY and Media Access Control (MAC) layer 164; 2) software layers to implement 3G, 4G, WAP and WIFI protocols and communicate with the appropriate protocol layer in block 164; and 3) SMS connectivity to implement the SMS protocol and communicate with the appropriate protocol layer.

FIG. 5, which is comprised of joined FIGS. 5A through 5E (hereafter referred to as FIG. 5) is a flowchart of a typical processing flow by client device software including the “client application” which handles metadata processing. The flowchart of FIG. 5 represents one embodiment for a software process which will work in any device in Categories 1-4. In other embodiments, the software can be customized to eliminate processing steps that do not pertain to devices in other categories other than the category of the host device in which the client application is running. In general, most all these different embodiments will share the characteristics that they: 1) cooperate with the other software and hardware of the host device to display the metadata, 2) determine themselves or from data passed to the client application from other Hardware/Firmware/software on the host device what type of click event occurred; and 3) do processing to carry out whatever communications upstream are necessary over whatever upstream digital data transmission channels are available when they are available to attempt to satisfy the user's indicated interest and send click events upstream, the upstream digital data transmission channel possibilities including the internet, cellular WAP protocol connected to the internet, SMS channel connected to an SMS termination in a cellular system, or WIFI or WIMAX infrastructures to connect to the internet. The exact details of the client application can vary but they all must display the metadata, receive data about click events and send the click event data upstream in any channel. Most embodiments will be able to communicate over the internet to carry out communications necessary to satisfy the user's interest.

Turning to the process of FIG. 5, step 200 represents the process of the receiver f186 receiving the audio and video data of the broadcast and the other data transmitted. The metadata will be possibly in two different sets of data: the in band metadata will be in the PAD bits of the audio data and the out of band data will be on data path 146. In step 202, the kernel sends the audio broadcast data to audio decoder function 188 for decompression and sends the video broadcast data to the video decoder function 190 for decompression and conversion to a format suitable. Image data is sent to the image decoder 197 for decompression and conversion to a format for display if necessary. The audio data and the data on line 146 are sent to the client application 192 for extraction of the in band metadata and linking of the in band and out of band metadata and further processing. All this is represented by steps 204 and 206. In step 204 the audio and video decoder functions send the decompressed audio and video data to the application framework 194 for display and playback.

In step 208 the client application makes the appropriate function calls to the application framework application programmatic interface (API) to cause metadata that needs to be displayed to be displayed (sometimes in a separate window from the broadcast video or image). In order to make it easy for the user to express interest, typical displays of metadata include display of one or more of the following:
a “call” button which, when selected, will cause the phone to initiate a cellular call to a phone number in the metadata (and usually displayed so a landline can be used also);
a “buy” button which, when selected, will cause an upstream web services request to be generated and sent to an e-commerce server to start a purchase transaction;
a Uniform Resource Locator (URL) which, when selected, causes the appropriate upstream internet communications to be generated to visit the website identified by the URL and the webpage identified by the URL to be sent back to the client device and displayed by the combination of the web browsing function 196 extracting the web page data from the TCP/IP packets and sending the data to the kernel which sends the data to the client application 192 which makes the appropriate function calls to the application framework and passes the website data to it for display;
a coupon thumbnail, which, when selected, causes the coupon to be printed or otherwise enabled for use in any way to make a purchase; and/or
a menu of podcast titles of podcast files which are available either in the memory of the device or those that can be download from the internet which may be of interest to the user.

If the metadata is a spliced in audio clip and the broadcast is or has an audio component, the client application works with the application framework to interrupt the broadcast audio from time to time to play the metadata audio.

Step 210 represents the process of the client application to determine what type of click event occurred. This represents the process of the application framework monitoring the user interface devices like touchscreen, keyboard and pointing device with select switch to determine which type of “click event”, i.e., expression of user interest, has occurred. Selections of any one or more of the above identified types of interest indication or clicking on an ad is a “click event” and the fact that it occurred and which one occurred will be reported by the application framework 194 to the client application 192. The client application then processes the click event in the appropriate way. The different types of processing for different click events are displayed on the flowchart of FIG. 5 by different lines of processing.

If the “buy” button is clicked, step 212 is performed to create a web service request addressed to the appropriate e-commerce server to fulfill the buy request. In creating the web service request, the client application collects the data it needs for the request from data about the user it has stored in memory and from the metadata. Information collected from the metadata usually includes (but not limited to) song name, artist name, album name, book name or service name. This information is used to communicate with a web server. The web service request communications are constructed using the standard SOAP or REST protocols in most embodiments. Currently the URL of the e-commerce server to which the web service request is to be sent as well as product ID is broadcast but this limits ecommerce transaction to the broadcaster preferred sites. The receiver could direct this request to any ecommerce site and each receiver manufacturer could have a relationship with their own preferred vendor. This does not preclude in any way the current way of broadcasting the URL of the e-commerce server (broadcaster preferred vendor) to which the web service request is to be sent as well as the product ID in that store. In both cases, information about the transaction, the is sent upstream to the advertiser, broadcaster or whoever else is interested in collecting that information for monetary compensation or other purposes. The information collected about the user for inclusion in the request may be the users user ID and password for the particular e-commerce server being contacted, his or her's name and address, phone number, etc.

In some embodiments, a user of the client device may respond to something in the broadcast or the metadata by indicating in any way a desire to contact a social networking site like Facebook or Twitter. In such embodiments, a web service request to contact the social network the user wishes to contact is generated and sent upstream by the client application by making a function call to the web browsing software 196, passing it the URL of the social networking site to contact and passing it as arguments the data to be posted on the social networking site. The web browsing software 196 then uses the internet connection (when it becomes available it if is not an always on connection) to make an API function call that allows for communication with the social networking site and passes it the data to be posted, tweeted, etc. The data can come from any combination of metadata, a broadcast ad, a broadcast program or data entered by the user on the host device. The same process applies in case the user is prompted by an ad or program to send a text message. The user types the text message in response to an ad or program, and the client application 192 sends it to the web browsing software 196 for sending as a text message to a recipient entered by the user and then reports a click event upstream. In other embodiments, a user of a client device with internet access may be surfing a social networking site and see something on the social network website like an ad that has been forwarded by a friend or acquaintance from a broadcast receiver that the user want to respond to. In such embodiments, the client application sends a click event upstream when the user clicks on an ad on a social network site and generates a web service request addressed to the appropriate server to respond in accordance with the user's wishes.

In some embodiments, a user of the client device may wish to share information about the advertisement, song or program and/or the advertisement, song or program itself with friends using Social Networking sites like Facebook or Twitter. In these embodiments, the ad which the user wishes to share is posted to the social networking site along with the metadata associated with the advertisement, song or program by the mechanism described herein. Posting to social networking sites are accomplished in these embodiments of the client application, by using the application program interfaces that are provided by these web sites as is the case for other embodiments. In addition, to posting metadata and any associated ads or images. In these embodiments, the client application functions to splice out the audio and video content such as advertisement, song or program using the transition markers or a metadata transition in the broadcast and posts the audio or video clip copied by the client application into memory to these social network websites as a audio or video clip. This works the same way as ad splicing described elsewhere herein, except the ad to be spliced in is not retrieved from memory, it is copied from the broadcast and it is not substituted on the host device, but is, instead, sent upstream over the internet connection to a social network as a post. Of course, royalty rights need to be maintained when sending song and other programs but this is less relevant for an advertisement because the advertiser is interested in getting a large audience for his advertisement or promotion. In the case of songs or programs sending clips to friends may initiate additional song or other purchases.

In other embodiments, a user of a host device with internet access may be surfing a social networking site and sees a posting on the social network website like an advertisement, song or program that has been sent by a friend or acquaintance from a broadcast receiver, and the user host device will respond by clicking on the posting. This will cause the client application in the host device to send a click event upstream. This is equivalent to a click event for an advertisement on the receiver itself. In addition, song and other purchases could also be initiated and again these are equivalent to a broadcast receiver initiating these purchases. In both these cases a monetary compensation could be provided to the broadcaster, owner of the social network site, receiver manufacturer etc. Social Networking Clicks: This Innovation Counts Clicks By Users of Social Networking Sites where the content originated from a broadcast

How Clicks on Ads Sent Up to the Social Network from a User of a Broadcast Receiver and how do the Resultant Clicks Get Accounted for

1. User of the host device will send metadata and the audio/video clip about the advertisement, song or program to friends and acquaintances using the API supplied by the social network site. In the case of advertisements the posting will contain a URL. In the case of song or any kind of purchase, the receiver would communicate with a web server and create a URL link that can be sent. The posting will also contain information about the click recipient for any user action on the social networking site.

2. The social networking application will recognize that the posting from a broadcast receiver is different from a generic posting using the special markers in the posting. It will parse the posting and extract the URL associated with an advertisement or a link to a web service and make it clickable link. It will also determine the click recipient for any user action. When the recipient of the post clicks on URL associated with an advertisement, then additional information about the advertisement is downloaded and provided to the person who clicked on the advertisement. In the case of a song or other purchase, there is a link to the e-commerce site page that allows one to initiate a purchase. Alternatively, the social networking application could use the metadata in the posting to communicate with the webserver and complete the transaction. In this scenario, the receiver does not have to communicate with the ecommerce site and all the communication is handled by the Social Networking Application program.

3. In all of the above cases, the click or purchase will result in monetary compensation to any of broadcaster, owner of social network site as well as the receiver manufacturer. The click recipient is determined from the steps above.

After the web service request is put together, the client application sends it to the upstream connectivity software function 196 for transmission upstream if there is a currently active connection to the internet. If not, the web service request is stored in memory for later transmission upstream when an active internet connection is established. The actual process that happens in each different category of client device depends upon whether the client device has an always on internet connectivity such as smartphone with a dataplan or a computer or a Direct Broadcast Service (DBS) television receiver or Digital Video Recorder with an Ethernet connection to a router connected to the internet or an iPad with 3G connectivity. The various possibilities will be shown in FIG. 5 by different lines of processing steps.

The client application causes this web service request to be sent upstream over the internet if there is an active internet connection, and, if there is no active internet connection, the web service request is stored in memory for later transmission when an active internet connection becomes available. Whether there is or is not an active internet connection at the time the web service request is created is determined by step 214. This step is not performed in client devices that have an always on internet connection in some embodiments, but may be performed in other embodiments even in devices that have an always on internet connection to make sure the connection is working. Sometimes modems lose sync or routers fail, or the phone is out of cellular coverage area, etc. so this step may be performed in some devices. If this step is not performed in a particular client device with an always on internet connection, processing flows from step 212 to step 216. If this step is performed in the particular client device, and no active Internet connection is detected, step 218 is performed to store the web services request in memory.

Assuming there is an active internet connection, step 216 receives the web services request from the client application and sends it upstream over the internet by controlling the PHY layer hardware in the device to send the request out on the internet. This means the data of the web services request will be packetized into whatever packet format is used by the particular device's PHY layer: WAP packets encapsulating TCP/IP packets for cell phones, TCP/IP packets for other devices directly connected to the internet, or whatever packet format is used on the upstream medium.

The web services request usually results in another web page that the user has to interact with such as view details about a product and select the “add to cart” button, etc. The data of this webpage is packetized and sent back using whatever web browsing packet format/protocols and downstream transmissions mediums are used when the client device browses the web. These packets are processed in the client device in the same way all incoming web pages are processed when the client device browses the web. Once the data is depacketized by the internet connectivity software 196, it is passed to the client application 192 via the kernel 186. The client application passes the data to the application framework for display and/or playback by making the appropriate function calls to the API of the application framework and passing the data to it. All this is symbolized by step 220. The user may interact with the displayed web page and that interaction is sent back up to the e-commerce server which may send another web page down as part of the transaction. This ping pong exchange of data continues until the buy transaction is completed. Step 222 represents the process of exchanging communications until the transaction is completed.

Step 224 represents the process of sending the click event upstream. This can be by any digital upstream pathway including the SMS digital data channel upstream or via the internet. The upstream click event packet or packets will contain data identifying the item in the metadata which generated sufficient interest for the user to do something in response to it which the client device detected. Other data may also be sent with the click event such as the identity and/or income level of the user, user viewing/listening preferences, user zipcode, etc. This data is called metric data. Step 224 is optional, and, in some embodiments, is eliminated where interest is inferred from the fact that a web services request is sent upstream in response to an ad for a product or service or metadata that somehow relates to the subject of the web services request.

If an internet connection did not exist at the time the web service request was created, step 218 stores the web service request and step 228 starts monitoring for an active internet connection. If one is not found, the device waits and keeps trying until an active internet connection is found. Once an active internet connection is found, test 230 is performed to determine if the user still wants to connect and send the web service request or carry out whatever other communications are needed to satisfy the interest he or she expressed earlier. The processing of test 228 is only done if the host device is a category 2 device or a category 3 device. Category 2 devices are any devices which need to be in a WIFI or WIMAX hotspot to establish a connection. Examples are iPads or tablet computers or laptops without 3G connectivity but with WIFI or WIMAX transceivers and with a digital broadcast receiver chip such as an HD radio chip built in. Category 3 devices are devices that do not have any internet connectivity and get an indirect access when they are docked with a personal computer that has an active internet connection by direct connection to a router or by a WIFI or WIMAX connection or which has a datacard which can be activated to establish an internet connection through the WAP protocol and a cellular provider's servers. In some embodiments, the client application which is installed in the client device is specialized for the category of client device it is installed in. For example if the client application is installed in a category 1 device with an always on connection to the internet, the processing in the line of processing starting with steps 218, 228, 230 can be eliminated by not being in the code at all or automatically bypassed by configuration data indicating the client application is installed in a Category 1 device which causes these steps to be bypassed.

If the host device is a category 3 device that needs to be docked to a computer or other device with an active internet connection, step 228 represents the process of checking with a conventional docking function 195 in FIG. 4 which interfaces with conventional docking circuitry 193 in FIG. 3 to determine if the host device 123 is docked with a computer or other device with circuitry to establish an internet connection and if an internet connection is established by that circuitry. The docking function includes all software needed to make the appropriate function calls and send the appropriate arguments to software in the computer or other device to which the host device is docked to cause it establish an internet connection and to send and receive TCP/IP packets over the internet connection. Such packets can be used to send click events or ad monitoring data upstream and to send transmissions for e-commerce transactions upstream and receive web pages in response to enable interaction with the e-commerce server or for any other internet communication necessary to carry out the functions described herein.

Processing by the client application 192 in some embodiments omits step 230 and just assumes the user still want to carry out the purchase transaction or do whatever other communications on the internet are necessary to satisfy the interest expressed earlier. Assuming the test of step 230 is performed, and the user indicates he still wants to connect, step 232 is performed to retrieve the web service request from memory and send it upstream. In the case of a Category 2 device (anything that needs to be in a WIFI hotspot to have internet connectivity such as iPads without 3G connectivity), the upstream web service request is sent by making a function call to the WIFI function in block 196 in FIG. 4 and passing the web service request data to it for packetization into TCP/IP packets encapsulated in WIFI packets which are passed it down the protocol layer circuitry for WIFI in block 164 in FIG. 3. Another case is a Category 3 device which only has an internet connection when it is docked with a computer with an internet connection. Usually, the docking event causes an application to launch and establish an internet connection. In such a case, the client application sends the web service request to the application program which has an active internet connection for transmission upstream on the internet.

After step 232, steps 222 and optional step 224 and step 226 are repeated to complete the transaction and send the click event upstream. In some embodiments, the click event communication includes metric data regarding the user and the product or service purchased.

Returning to step 210 in FIG. 5B, if the type of interest indicated is not a buy request, processing vectors to test 234 on FIG. 5C to determine if an ad click occurred or if the call button was clicked upon. If either an ad click or a call button click was detected, test 236 determines which one. If an ad click occurred, step 238 looks for the additional information about the advertisement in memory of the device, and, if found, displays the ad or whatever information about the product or service the device in the ad the device has stored in memory. If there is no additional information about the ad found in memory or even more additional information is requested, then test 240 determines if there is currently an active internet connection. Again, this step may be eliminated in embodiments where a customized client program or a client program which has been configured for the category of device it is in is installed. If no active internet connection is found, test 243 is performed to determine if the host device is a Cat 4 device. If not, processing returns to test 240 to test for an active internet connection. If the client application is running in a Cat 4 device and the ad clicked upon was not found in memory, whatever information found in memory is displayed, and step 245 to send a click event upstream via the SMS data path. Then processing proceeds to step 246 to end this line of processing and return to step 200.

Returning to test 240, if the host device is one where an active internet connection can be achieved, once an active internet connection is found, processing is vectored to step 242. Step 242 sends an upstream request for the ad or more information about the product or service which was the subject of the ad and displays or playback the information retrieved. Path 241 through the process is taken when the host device is a category 1 device with an always on internet connection such as a smart phone with a data plan or an iPad with 3G connectivity and a data plan. Path 241 will be taken for a class 2 host device (needs to be in a WIFI hotspot) if the device is currently in a WIFI hotspot, such as an iPad without 3G connectivity. Path 241 will also be taken if the host device is a Category 3 device (needs to be docked or connected to a computer with an active internet connection) such as an iPod which is coupled for sync to a Mac.

After step 242 sends the upstream request over the internet, step 244 is performed to send a click event upstream and this line of processing ends at step 246. Processing, as is the case for all “end” steps in FIG. 5, returns to step 200 in FIG. 5A to receive more broadcast data and metadata and monitor for other click events.

If test 234 determines that the call button was clicked, test 248 is performed to determine if the host device is a Cat 1 device such as a smart phone with an always on 3G or 4G internet connection or a device such as a computer with an always on internet connection or a data card which can be launched to establish an internet connection and with a voice over IP (VoIP) application like Skype™ or Google Voice™ installed and running. If test 248 determines the client application is running in a Cat 1 device, step 250 is performed to send a request to the phone function's API to initiate a phone call, and the number to call from the metadata is passed as an argument. This causes a phone call to be initiated on the cellular phone network. Steps 244 and 246 are then performed to send a click event upstream via the Internet, and end this line of processing and return to step 200.

If step 248 determines that the client application is running in a Cat 4 feature phone with no internet connectivity but with an upstream SMS channel, step 252 is performed to send a request to the phone function API to initiate a cell phone call to the number in the metadata passed with the API function call. Then step 254 is performed to encapsulate the click event data into SMS packets and send the click event data upstream via the SMS channel. Then step 246 is performed to return processing to step 246.

In some embodiments (not illustrated here), if the device has no phone call functionality, the request can be sent to the kernel for transfer to a voice over IP application program such as Skype or Google Voice to initiate a phone call over the internet connection. If there is no currently active internet connection, the request to initiate a call is cached and sent later when an active connection is established after first inquiring of the user if she still wants to make the call and receiving an indication that she does.

Returning to test 210 on FIG. 5A, if the click event is not a buy and processing vectors to test 234 which determines the click event is not an ad click or a call button click, test 256 is performed to determine if the user select a podcast for playback or selected a web page from a broadcast website. Sponsored web pages generated by broadcast websites can be broadcast for advertisement delivery by transmitting the web page data over a broadcast medium.

The content that is broadcast in this case is sponsored high demand web pages like news, weather, sports scores, etc. that could be sent over the internet, but which, because the internet is a unicast network and because of the high demand for these web pages, would consume too much bandwidth. To save bandwidth, these high demand web pages of more or less static content are sent over the broadcast network instead of the internet. For example, high demand static web content consisting of banner ads, XML, CSS, JavaScript, HTML, etc. content files can be transmitted via the broadcast network. This content can be browsed on a Cat 1 through Cat 4 device using the embedded digital broadcast receiver without having to access the internet via a unicast network connection.

It is also possible to use this paradigm in a species of the invention where a Compensation Per Click (CPC) model for ad compensation is grafted onto the broadcast paradigm. In some embodiments, advertisements are embedded in the broadcast websites and the user can click on them in which case, processing proceeds as previously described for an ad click on an ad in the metadata. In this embodiment, it is possible to produce more dynamic web content by on occasion updating the data being transmitted over the broadcast network by making an upstream more information request over the internet and receiving one or more other web pages with more information and which are in less demand over the unicast network, i.e., the internet. The Cat 1 through Cat 4 device receives the new content in response to the click event and upstream “more information” request and refreshes the browser view as needed.

More specifically, if the user of the Cat 1 through Cat 4 devices wants to browse another page, click on a link or go to an advertiser's main web site and that destination is not a part of the web page content being broadcast, then the internet connection over the unicast network (if available) is used to make an upstream request and access this content. In other words, the most commonly accessed web sites would be broadcast to reduce the BW consumed on unicast networks and the less popular websites would be fetched over the unicast network. In other words, the broadcast content would be augmented by content that can be accessed on category 1 and 2 devices when there is an internet connection or downloaded speculatively based on data mining of users interest in class 1, 2 and 3 devices.

Broadcast content is sometimes used to augment the main audio content. Also in the website pages there will be clickable advertisements similar to internet web pages. One way the client application processing would work in this scenario is shown in the steps following test 256 on FIG. 5C. In this scenario, the user of the Cat 1 through Cat 4 device has her embedded digital broadcast receiver tuned to receive the broadcast web page of interest. The user sees something upon which he would like more information such as he would like to visit the advertisers website to browse books or songs or search for a specific book or song, watch video clips or hear audio clips of something advertised on the broadcast page or buy a video or song. The user clicks on an ad, a link, etc. to receive another web page. This click is interpreted as a click event and brings the client application to the test 256 which determines the click event was for something on the broadcast web page. That vectors processing to optional step 260 which, if performed speculatively, makes upstream requests for all or some of the web pages which the user may be interested in seeing given the web page broadcast she is tuned to. These upstream requests are made over the internet if there is an active internet connection in Cat 1 devices or stored and sent upstream when an internet connection is available in a Cat 2 or 3 device. When there is an active internet connection available, the requests cause web pages to be sent back downstream on the internet and step 260 stores them in memory of the device. Then step 262 is performed to determine from the click event which particular web page has been requested. Test 264 then determines if the web page of interest has already been stored in memory, and, if so, retrieves it from memory and displays it. Then step 269 is performed to send an upstream click event over the internet, and step 270 ends this line of processing and vectors back to step 200. If test 264 determines the requested web page is not in memory, test 266 is performed to determine if there is currently an active internet connection. If not, the client application waits and tests for an active internet connection again later. Once there is an active internet connection, if the device has been waiting, the user is asked by a displayed message if he still wants the information. This step is not shown and is optional. If the user still wants the information after waiting, or if test 266 determined that there was an active internet connection when the request was made, step 268 is performed to send an upstream request over the internet for the desired page, receives it and displays it. Then step 269 is performed to send an upstream click event over the internet if there is any kind of monetary value associated with the click. Then step 270 ends this line of processing and returns to step 200. If the user clicked on a phone number in the broadcast web page, a function call to the phone functionality is initiated to initiate a call to that phone number and a click event is sent upstream.

If step 256 determines the click event was to listen to a podcast, optional step 272 may be performed to speculatively download podcasts over the internet which may be of interest to the user when he is listening to some specific broadcast. Podcasts are Digital Recordings of broadcasts that were made or were just generated without ever having been previously broadcast. Podcasts are stored online in servers. Lots of Radio Broadcasts are posted online episodically as podcasts. Use of the broadcast infrastructure to distribute podcasts is very cost effective since they may be of wide interest and would consume too much bandwidth if distributed on the unicast network, i.e., the internet.

The podcasts of possible interest to the user listening to a specific broadcast could be cached on the device ahead of the time if there is an active internet connection, and that is what optional step 272 does. In addition, on Class 2 and Class 3 devices, podcasts can be downloaded into the device and pre-cached when in a WIFI hotspot and connected to the internet. In a class 1 device, advertisements could be downloaded and cached when the device is connected to a cheap (non-cellular) network like a WIFI or WIMAX network. This cache would augment the podcasts that are broadcast. Caching of podcasts on the device in advance of request could be done based on User Preferences or based on machine learning about the programs listened to by the user.

Another mechanism to store (cache) podcasts on the receiver would be record the program when it is broadcast live. The receiver will determine when the program is on the air by parsing the EPG/Schedule that is either broadcast or available over the internet. When the EPG is obtained from the internet the receiver may choose to use location to determine the local radio station as well as the time of broadcast. The recording could be initiated based on a user preference or speculatively based on understanding the user's interest. The receiver would wake up at the time of the broadcast and record the program. The program would be stored in non-volatile storage of the receiver. The program can be stored in the audio compression format used by the broadcaster (HDC or MPEG Layer 2) or it could be transcoded to a more popular format such as (MPEG1 layer 3 (MP3) or AAC v1/v2). The integrity of the recording can be determined by checking statistical metrics such as the percentage of the good audio packets received and other RF receiver statistics. The receiver SW would then use these measures to declare a recording acceptable and present it to the user. The off the air recording of the podcast is no different than the content downloaded of the internet.

The broadcaster could also be carousel the podcast content on a periodic basis as OOB data service. The receiver would store this podcasted data.

A Radio program could be associated with podcasts using metadata. This metadata could be used to search sites such as iTunes that have a catalogue of these podcasts using Web Services protocol. The metadata could also contain the URL and other information to allow a receiver to download the related podcast content. When the user is listening to a show then all of the related podcasts could be shown to the user, and that is what step 276 does if the podcast has not already been selected based upon the click event. In the case of Class 2 (w/o internet connectivity currently) & 3 devices only podcasts that are already cached on the device will be shown and that is the function of step 278. In the case of class 1 device or class 2 device (with internet access), all podcasts even the ones not cached can be shown. Step 278 displays a list of all podcasts already stored in memory in Category 2 and 3 devices, and, in the case of Cat 1 devices determines if the requested podcast is already stored in memory but displays all available podcasts. If the requested podcast detected by test 278 is already stored in memory, step 282 retrieves it and displays it. If test 278 determines the requested podcast is not already stored in memory, test 280 is performed to determine if there is a currently active internet connection, and waits and tries again if there is not. Once an active internet connection is established, an upstream request for the desired podcast is sent over the internet. The requested podcasts not cached are downloaded over the unicast network and displayed in step 284. Then step 269 is prepared and an upstream click event is sent over the internet. Then step 270 ends this line of processing and vectors back to step 200.

### A More Detailed Look At The Digital Broadcast Transmitter Equipment

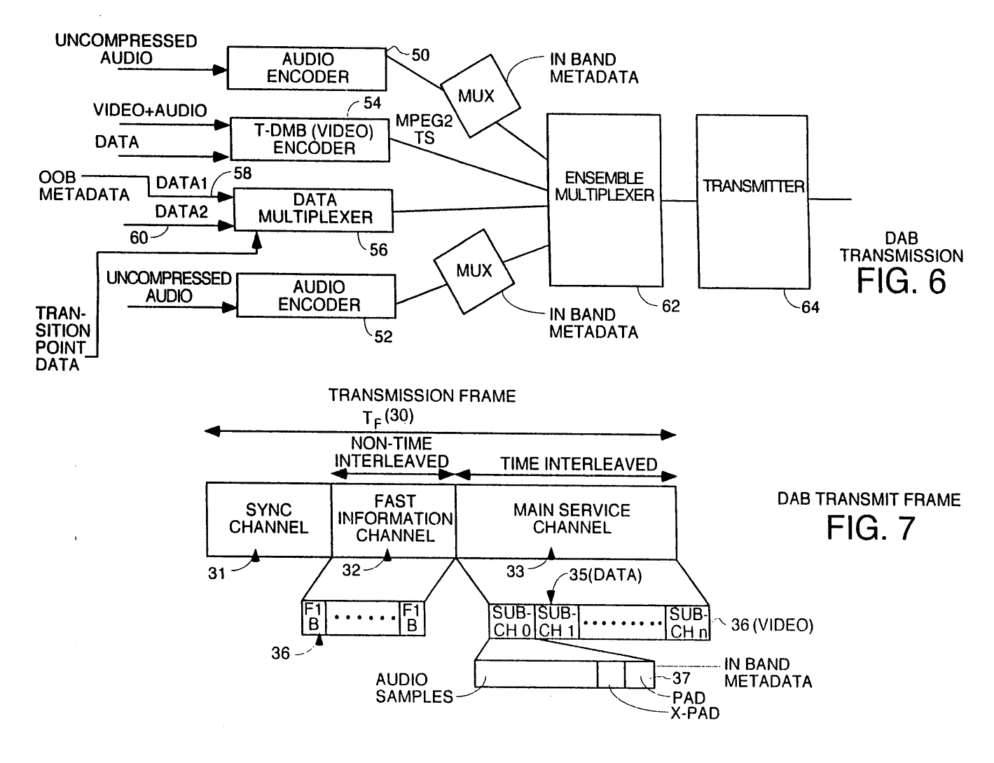

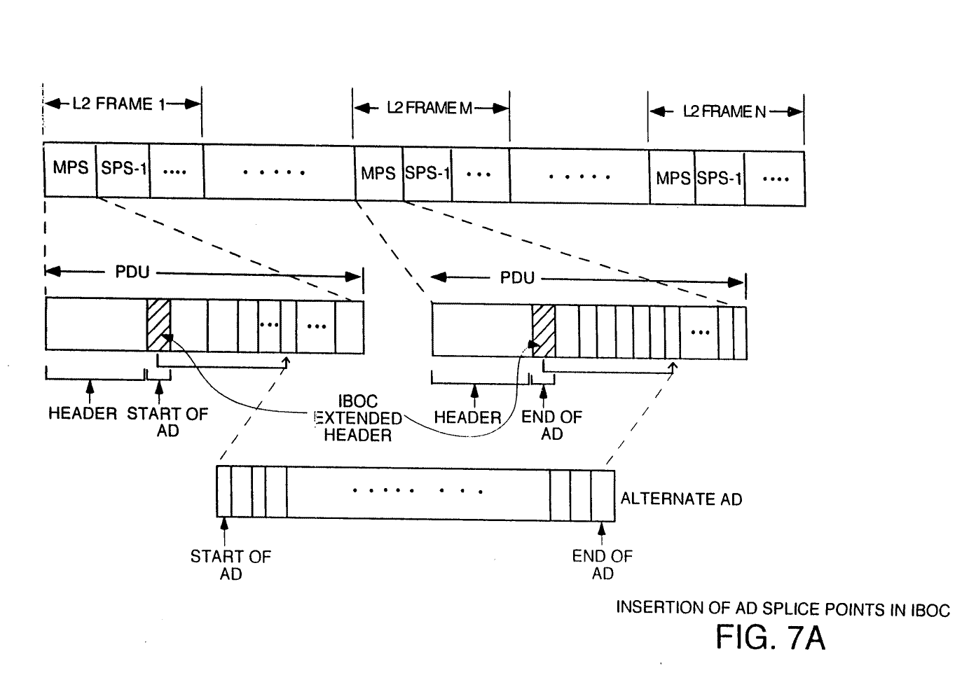

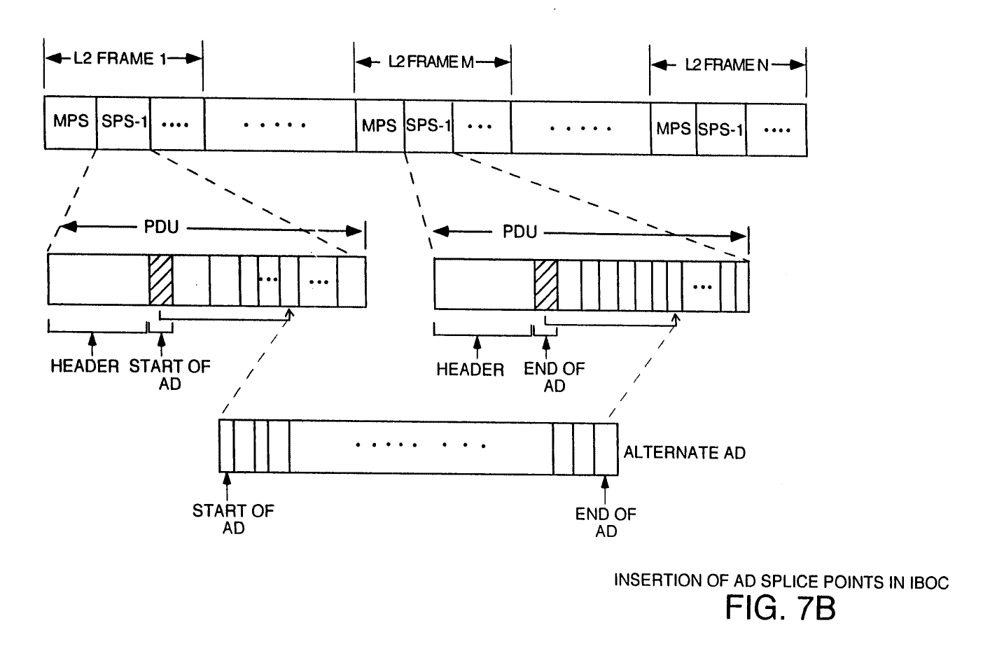

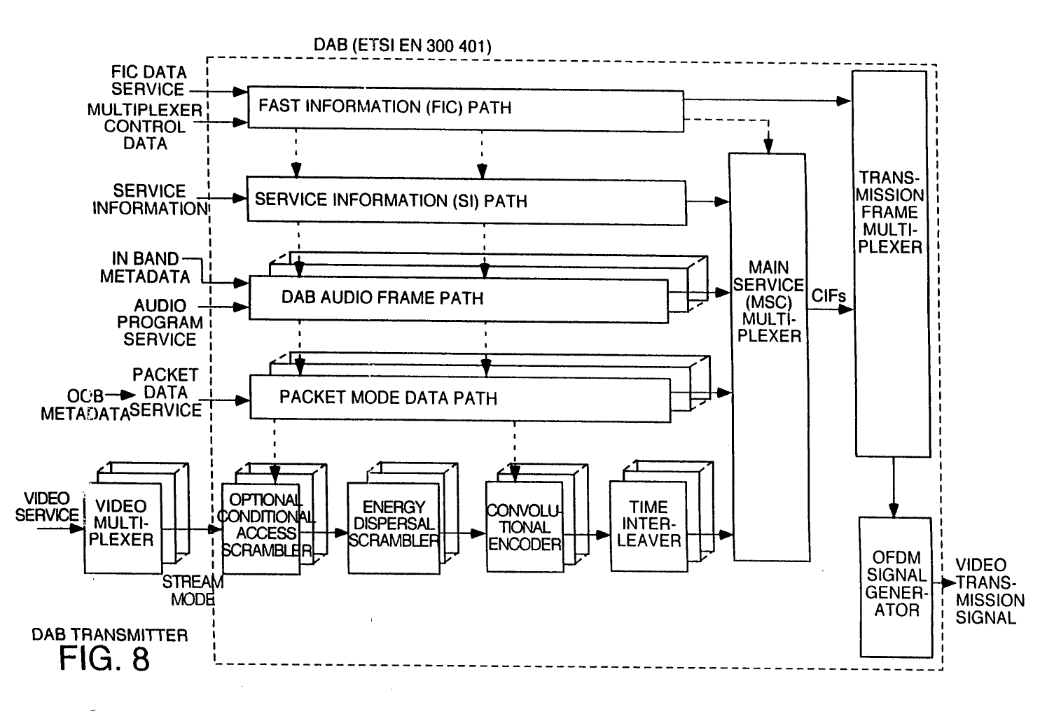

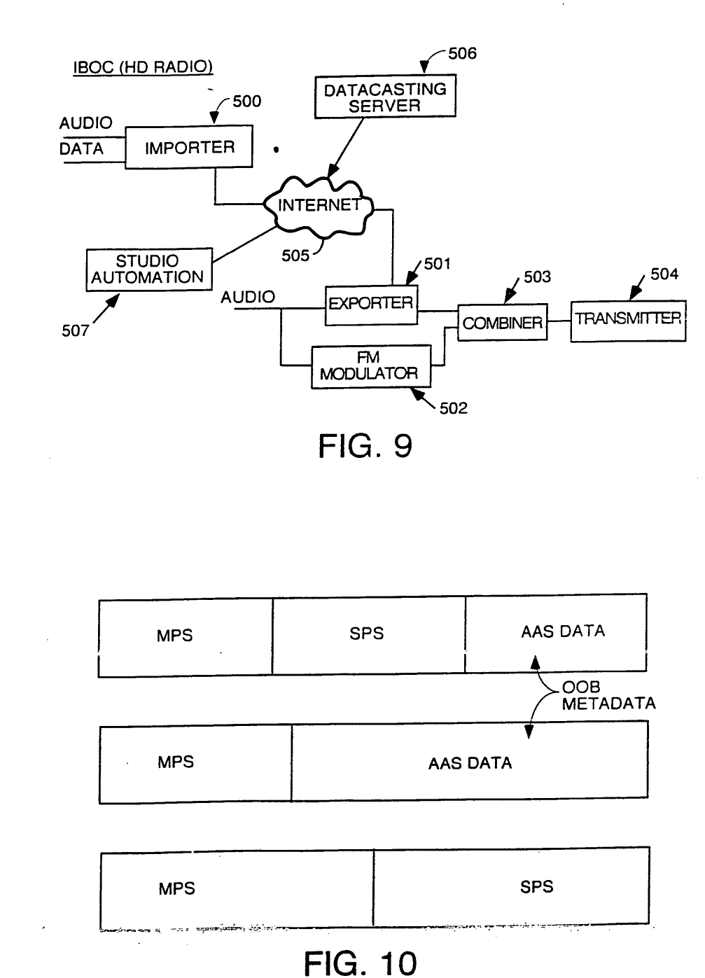

The following is a list of the equipment that will be in radio video broadcaster 100 for different types of downstream digital broadcasts. FIG. 6 is a block diagram of the broadcaster block 100 if the downstream broadcast is a Digital Audio Broadcast (DAB). FIG. 7 is a diagram of the transmission frame for a DAB broadcast. A DAB multiplexed transmission stream can carry audio and multimedia data. The DAB multiplex is comprised of the compressed audio, video and metadata generated by audio encoders 50 and 52, video encoder 54 and data multiplexer 56. An ensemble multiplexer 62 creates the DAB multiplexed transmission stream. A transmitter 64 arranges the transmitted signal into frames, each frame having the frame structure 30 shown in FIG. 7.
DAB/T-DMB
   Audio Encoder 50 and 52 compresses uncompressed audio data using standard compression protocols (AACv2 or MPEG1 Layer 2).
   Video Encoder 54 compresses video data using standard compression protocols (MPEG2/H.264).
   Data Multiplexer compresses out of band metadata arriving on lines 58 and 60 and multiplexes the compressed metadata together into a metadata stream.
   Ensemble Multiplexer 62 multiplexes the audio, video and metadata streams together into a DAB multiplex.
   Management SW, not shown, but described in the flowchart of FIG. 8, controls the operation of the DAB transmission equipment shown in FIG. 6.
   Transmitter 64 arranges the DAB multiplex into frames (30 in FIG. 7).

The Transmitter 64 arranges the transmitted signal in a transmission frame structure 30 in order to facilitate synchronization at the receiver. The transmitted frame has duration T_{F}. Each transmission frame 30 is divided into a sequence of Orthogonal Frequency Division Multiplexing (OFDM) symbols. Each symbol consists of a number of carriers. Four different transmission modes are defined. The number of OFDM symbols in a transmission frame 30 is dependent on the transmission mode. The details of the OFDM parameters are provided in [Ref 1]: ETSI EN 300 401 “Radio Broadcasting Systems: Digital Audio Broadcasting (DAB) to mobile, portable and fixed receivers”, May 2001 (which is hereby incorporated by reference).

Each transmission frame comprises three elements:
Synchronization Channel 31
Fast Information Channel 32
Main Service Channel 33

### Synchronization Channel 31

The synchronization channel 31 in any transmission mode shall occupy the first two OFDM symbols of each transmission frame 30 and carries data that allows the receivers to synchronize to the transmitted frame structure stream.

### Fast Information Channel 32

The FIC 32 is used to provide rapid overhead and low delay data to the receiver. The FIC contains several types of information:
MCI (Multiplex Configuration Information): These data are specific to the DAB Multiplex (or Ensemble) organization. It includes a list of Sub-channels (content type, position, protection, bit rate) and Services characteristics (pointers to Service Components).
Service Oriented Information: These data are specific to the contents of the sub-channels such as Program Type, Program Language and Program Number, etc.
Network Oriented Information: These information are specific to the overall broadcasting system e.g. the list of transmitters broadcasting the Ensemble, the cross-references of Services over various Ensembles, etc.

The FIC is a non-time interleaved data channel with fixed error protection. The FIC information is repeated cyclically for fast receiver synchronization and start up. The format of the FIC and the Multiplex Configuration Information is described in great detail in [Ref 1] and can be well understood by someone skilled in the art.

### Main Service Channel (MSC) 33

The MSC 33 is subdivided into sub-channels (34,35,36). Each sub-channel has a capacity that is an integer multiple of 8 kbps. A sub channel carries a single service of audio (34), video (36) or data (35). There are two transport modes in the MSC: one is called the stream mode and the other the packet mode.

Stream Mode is designed for continuous and synchronous streams such as Coded Audio. For example, with 48 KHz sampling rate there is a constant size packet that is available every 24 ms.

Packet Mode is used to transport asynchronous data. Multiple application data streams (up to 1023) can be multiplexed on a single packet mode sub-channel. It is also possible to add an outer Reed Solomon Forward Error correction to increase reliability. This mode is used in the T-DMB specification to carry video. The Video is sent as MPEG2 Transport streams.

DAB multiplex is organized into services either audio or data. Each service could consist of different data streams such as audio, data etc. and these are called service components

When metadata is carried in stream or packet mode as a separate data service, then this is called out of band (OOB) transmission of metadata. It is also possible to transport data OOB in another service component than the primary audio service component. This mechanism is used in cases where the data is associated with the primary audio component.

In addition to OOB data transport, there is an additional method of transmitting metadata that is closely related to the Audio DAB (MPEG1 audio codec inhabiting the Presentation Layer of the OSI Model) or DAB+service (AAC audio codec inhabiting the presentation layer). This is done “in-band” in the Program Associated Data field (PAD). PAD is transmitted at the end of each DAB Audio frame 34, and in the data stream element of DAB+frame. PAD bits are shown at 37 in FIG. 7, and consist of 2 bytes at the end of each DAB frame. The PAD can be extended with X-PAD to carry larger amounts of data—up to 64 kbps. In FIG. 6, the output of each audio encoder goes into a multiplexer 51 and 53, respectively. Each of these multiplexers receives in band metadata and puts it into the PAD bits of the audio frames being received from the audio encoder.

Multimedia Object Transport (MOT) is a transport protocol for transmission of multimedia content objects. During transport the MOT entity could be split across segments. These segments are mapped to packets and transported in a packet mode sub-channel or in X-PAD. The segments are reassembled at the receiver. The segments are perused by the receiver in the client device, and the receiver picks up the segments that it needs. This introduces redundancy and a loss of 1 segment does not require waiting for the full object to be rebroadcast. MOT is used for transporting objects such as file or directory of files.

The format of the Main Service Channel MSC 33 is described in great detail in [Ref 1] and [Ref 2] (which is hereby incorporated by reference) Digital Audio Broadcasting, Principles and Applications of DAB, DAB+ and DMB 3^{rd} and can be well understood by someone skilled in the art.

Multimedia Object Transport (MOT) are currently used for transporting Broadcast initiated Slideshows, Electronic Program Guide as well as for sending downstream broadcast only websites. MOT is an ideal transport mechanism for delivery of advertisements both associated with the audio content or when there is no association. MOT can also used for sending alternate advertisements that can be cached by the client application in the receiver device and inserted at the client device using ad insertion processing to insert ads that are more likely to interest the user of the client device than other ads sent downstream in the metadata either in band or out of band.

FIG. 8 is a block diagram of a DAB broadcast transmitter giving more detail about the functions within the blocks of FIG. 6 and showing a Main Service Multiplexer which generates the Main Service Channel portion of every frame and a Transmission Frame Multiplexer which combines the MSC portion of each frame with the Fast Information Channel portion of every frame. An OFDM Signal Generator modulates the digital data of each transmission frame 30 onto RF carriers for transmission.

### IBOC (HD Radio)

The transmitter for an HD radio broadcast site is symbolized by the block diagram of FIG. 8, and comprises:
Importer 500
Exporter 501
Management SW (not shown)
Transmitter 504

HD Radio, which originally stood for “Hybrid Digital”, is the trademark for iBiquity's in-band on-channel (IBOC) digital radio technology used by AM and FM radio stations to transmit audio and data via a digital signal in conjunction with their analog signals.

FM stations have the option to subdivide their datastream into sub-channels (e.g., 88.1 HD1, HD2, HD3) of varying audio quality. HD1 is referred to as Main Program Stream (MPS), HD2, HD3 are referred to as Secondary Program Services (SPS) and the data is referred to as Advanced Application Services (AAS) data. Any out of band metadata sent downstream in HD radio embodiments is sent as AAS data.

In addition to the AAS data, there is also the Program Specific Data (PSD) that is synchronized with the audio content. In band metadata can be sent as PSD data. HD1 sub-channel is used to simulcast with the Analog FM signal and the two streams are synchronized. The remaining sub-channels carry new audio and data content. The FM hybrid digital/analog mode offers four options (Modulation Profiles) which can carry approximately 100, 112, 125, or 150 kbit/s of aggregate bandwidth that can be allocated for audio or video. It is also possible to transmit up to 300 Kbps of aggregate bandwidth when the analog FM broadcast is removed.

Importer (500) is a piece of studio equipment that is used for generating all the content except HD1. The importer has application programs running on it that allow interfacing with a datacasting server (506) that can push data content to the importer through the internet 505, said data being destined for broadcast. The output of the importer interfaces with an exporter (501) through the internet 505 (or directly in some embodiments). The Importer also interfaces with studio automation software (505) that controls the bandwidth allocation as well what content needs to be broadcast. The studio automation software can generate the Table of Contents messages that can be used for indicating when certain content will be delivered over the air such as a schedule of podcasts or a schedule of ads. This Table of Contents is used for timeslicing the receivers so that their client applications can wake them up only long enough and at the right time to receive ads or podcasts or other information they want to store in memory. This conserves battery life in handheld devices with built in digital broadcast receiver chips such as an HD receiver chip.

Exporter (501) is responsible for aggregating the Main Program Stream (MPS), Secondary Program Stream (SPS) and AAS data. It is responsible for Coded OFDM (COFDM) modulation of the data stream frames onto one or more RF carriers that are to be broadcast with the analog FM modulated RF carrier that is part of the HD radio broadcast. The exporter also synchronizes MPS data with Analog FM.

FM Modulator (502) is used for doing the FM modulation to create the analog FM signal (the FM modulated RF carrier). The Analog FM and the output of HD exporter are combined to form the broadcast signal in the combiner 503 and amplified for broadcast in transmitter 504.

FIG. 10 is a diagram of the different OSI layer 2 PDU (on layer 2 of the OSI module, a Protocol Data Unit or PDU is a frame) possibilities, i.e., the different layer 2 frames possible combinations of Main Program Stream (MPS), Supplementary Program Stream (SPS) and AAS data that can be broadcast on the digital data modulated carrier of the HD broadcast.

In the IBOC system for HD radio, audio and data are transported in multiple logical channels. IBOC has multiple logical channels depending on the modulation profile. On each logical channel, Layer 2 (OSI model layer 2 is the data link layer) Protocol Data Units (PDUs) are sent which contain a mix of audio and data in different portions of the frame. The audio is sampled at 44.1 KHz and is organized as packets. Each packet is numbered (as seen in FIG. 11) and contains compressed audio and corresponds to 2048 PCM samples. This corresponds to 46.4 milliseconds (ms). Multiple variable size audio packets are aggregated together into a fixed length audio frame. Due to the fact that variable sized packets are being aggregated into a fixed length frame, the number of packets in a audio frame will vary around a mean.

FIG. 11 is a diagram of the audio frame format in HD radio broadcasts. Each audio frame has a header 508 which indicates the number of audio packets (1-64) and a list of pointers that point to the start of each audio packet within the frame. Each audio frame also contains Program Specific Data 510 which is metadata associated with the audio content. The audio frame is also provisioned to be extended to add additional header information in the Extended Header 506. This allows for extensions that are ignored by current receivers but provide additional information to new receivers as well as receivers which have an updated firmware. This “additional header information” extension 506 is used in some embodiments to transmit markers or pointers to mark which packet corresponds to the beginning of a song or the beginning of an advertisement, i.e., a transition point. These transition points are used by client applications in client devices in some embodiments to do ad insertion of ads that may be of more interest to the user than ads that are being broadcast and start at those marked transition points. This marker or pointer mechanism using extended header data is more precise than the metadata transition which could span many layer 2 PDUs since each layer 2 PDU could have a duration up to 1.486 seconds. Adding this information in the extended header reduces the ambiguity down to 46 ms which is not perceptible by a human listener.

### MPEG Transport

FIG. 14 is block diagram of a typical circuit portion of a broadcast transmitter that generates an MPEG transport elementary stream on line 704. An elementary stream (ES), as defined by the MPEG communication protocol, is usually the output of an audio encoder 701 and video encoder 700, each of which receive audio and video signals to be broadcast on lines 698 and 699, respectively. The elementary stream typically contains only one kind of data, e.g. audio, video or closed caption. An elementary stream is often referred to as “elementary”, “data”, “audio”, or “video” bitstreams or streams. The format of the elementary stream depends upon the codec or data carried in the stream, but will often carry a common header when packetized by packetizer 702 into a packetized elementary stream (PES). Video PES is on line 697 and audio PES is on line 695. For reliability challenged media like broadcast, the packetized elementary stream are multiplexed together by transport multiplexer 694, segmented into 188 bytes packets to which a 16 byte or 20 byte Forward Error Correction is added. Metadata can be added to the stream by supplying the metadata on line 693. The metadata is then multiplexed into the transport stream. The transport stream is then modulated onto whatever downstream carrier is going to be used to broadcast the audio, video and data.

MPEG transport streams have I frames. Both the MPEG transport streams as well as the Packetized Elementary Streams have splice points, typically done on I frame boundaries, which allow for adding a new stream. This mechanism is used at the receiver for advertisement insertion in embodiments where ad insertion is done at the receiver.

### Out of Band Ads

Modern digital broadcast network standards have the ability to send data services in out-of-band (OOB) channels. For example; OOB data can be sent as AAS data in the HD radio network, packet mode service in a DAB network or as auxiliary data in a ATSC M/H network (TV broadcasts to handheld devices like cell phones). These generic data channels can be used to transmit advertising content that can be linked to the main in-band broadcast to enhance/alter the original presentation in a variety of ways.

For one enhancement, the OOB channels are used to transmit visual images, either still pictures or video. These images would be synchronized with the main IB audio advertisement and would contain additional information about the advertisement. The IB and OOB advertisement data would be tagged to indicate that they are associated. The method of linking used for the association is depended on the broadcast network. As an example the two streams could use the same AD_ID code and this code could be one of the components of metadata that is transmitted. The user can retrieve, view and/or take action on this additional information at their discretion by a variety of mechanisms such as a button, link or any other interface prompt.

In addition to providing additional enhanced advertisement data in the out of band (OOB) channel, the OOB can be used to off load primary advertisement data from the main in band (IB) channel. By transmitting some of the advertisement content out of band, the IB advertisement duration maybe reduced allowing for a less disruptive listener/viewer experience. The advantage of reducing the duration of the advertisement spot is that it would lessen the probability that the viewer/listener would tune away when the advertisements are on air. Those listeners, who are actually interested in the advertisement can then view, listen or take action independently of the main audio experience.

Even in cases where there is no digital broadcast standard being transmitted, there are a plurality of methods which can be used to add a digital sideband that could be used to carry out of band advertisements associated data (AAD). As an example, with analog FM broadcasts a digital broadcast on the FM subcarrier could be used to carry this data. Another example would be with analog television broadcasts where the vertical blanking interval could be used to transmit this information. Also the white space between TV Stations i.e. between allotted bands in the spectrum space could be used to transmit this information.

Beyond just augmenting existing IB advertisements, another use of out of band delivery is that advertisements can be delivered to even those users who are not tuned to a radio or TV broadcast. Audio, video, text and/or picture ads can be loaded by the receiver 133 into the memory 156 of the host device 123 (or memory in the broadcast receiver 133 itself) in the “background” based on user demographics and preferences. These advertisements are only (not necessarily) played when the user is performing other tasks on the device or requests to view them when prompted. Exemplary times to play the advertisement would be when the user receives a phone call, makes a phone call, access their address book or any other application. There are numerous ways these advertisements could be displayed on the end device.

An ideal example of content that is very well suited to be broadcast OOB is store coupons. Coupons represent advertisement content that user would want to cache, pull up on their discretion and potentially shared with friends over social networks. The coupons can be presented to merchants directly from their smartphone providing the merchant accurate feedback on the delivery mechanism that was successful in getting the customer.

The OOB delivery is an excellent way to target the large demographic of feature phones which don't have internet connectivity. In Class 2 and Class 3 devices, OOB advertisements can be downloaded into the device and pre-cached. This cache would augment the broadcast content. In a class 1 device, advertisements could be downloaded and cached when the device is connected to a cheap (non-cellular) network.

### Advertisement Insertion: Splicing

In addition, to enhancing the advertisements transmitted in band (IB), out of band (OOB) metadata content can be used to alter the advertisements that are broadcast IB. One example would be to broadcast OOB the same advertisement as the one IB, but in another language. The in-band advertisement could be substituted with the alternate language advertisement based on a user preference.

In general, the main advertisement can be replaced with an advertisement that is better targeted to the end user. Such advertisement insertion is fairly common place in Video cable delivery but these are done at the head end. In this section we are talking about doing something different. In this embodiment, insertion of an ad which is better targeted to the end user is being done at the client device. One of the advantages with this innovation is that it allows terrestrial and satellite broadcasters to do localized advertisement insertion that was only available to cable operators. Also this is much more individualistic than the advertisement insertion that is done at the head end because the client application can gather data about its user such as viewing preferences, search subjects etc. and learn about the user's interests, hobbies, etc. The client application can then insert ads which are more likely to be of interest to the user in place of ads transmitted by the broadcaster which are less likely to be of interest to the user.

Ad insertion requires some information about the subject of the ad or at least the identity of the company whose product or service is being advertised in the ad, the duration of the ad and information about when the ad which is to be replaced is starting. Unique ad codes can encode information about the duration of the ad. The purpose of ad insertion is to substitute the main advertisement with an advertisement that is ad of more interest to the user of the device. This can be accomplished by taking the alternate advertisement that was broadcast OOB and splicing it at the right time in the main broadcast. The duration of the main advertisement and the alternate advertisement need to be matched one to one or by combining multiple advertisements. Information about when an ad is starting can be gleaned by the client application 192 monitoring the metadata and/or the main program stream to detect unique ad codes and/or transition markers that mark the beginning of an ad broadcast in the metadata or main program stream. In some embodiments, the client application monitors the metadata with a comparison process to determine transitions between different ads and ads and the main program. This is required when there are no explicit transition markers broadcast. The comparison process can be any process which can splice out an advertisement by any method. The transition markers which are broadcast or the detected transitions are used by the client application to splice in an ad from memory as a substitute for viewing and/or playback on the host device instead of a broadcast ad of the same duration. The substituted ad may be the same ad in the native tongue of the user or may be a different ad having a subject of more interest to the user as determined by the client application from data mining activities.

In some embodiments, a Table of Contents containing this information about the subject of an ad, its duration and its time of broadcast (or at least the information needed for ad insertion) is therefore broadcast in the metadata either in band or out of band. The Table of Contents in one embodiment includes data about when an ad or (broadcast segment) will start, its subject and its duration. The subject data can be implemented in any way. For example, a list of all possible subjects or products or services can be generated, and each subject, product or service can be given its own unique code. The client device receives the list of subjects and codes and stores it in memory and uses the subject data in the Table of Contents broadcast in the metadata to look up the subject of each ad or broadcast segment. The client device then uses its stored information about the interests and preferences of the user of the client device to insert ads from memory of more interest and of the proper duration at the proper time. The ads stored in memory are transmitted downstream in the metadata and also have unique subject codes associated therewith, said subject codes being used by the client device along with its preference data to make judgments regarding which ads from memory to insert for ads being broadcast.

A variety of data mining techniques can be used to better target the advertisement to the end user. Examples are: monitoring searches performed by the user using the host device; monitoring the current location of the user using the GPS or triangulation; monitoring which broadcasts are viewed or listened to by the user; monitoring which products and/or services or songs or videos the user buys using the host device, etc. Any known data mining technique can be used.

Advertisement insertion requires that there be splice points, i.e. start and end points for each advertisement. These start and end points are used in some embodiments to do the advertisement insertion. Advertisements are typically broadcast as 15 seconds, 30 seconds or 1 minute slots. Therefore, in some embodiments, only a starting point and a duration of the ad are sufficient to do ad insertion. The OOB advertisements that are cached would also match these slots. It is fairly obvious that two 15 second slots can be substituted for one 30 second slot. For advertisement insertion to work it is important that there be start and end markers in the metadata stream to indicate advertisement transitions. This is done by extending the DAB standard to add advertisement and song transition markers in the PAD or X-PAD bits. Since the audio packets correspond to 24 ms of audio at 48 KHz sampling rate. In IBOC, the advertisement and song transition points are added as audio frame extended header as described above. It is fairly obvious to people skilled in the art on how to modify the standard to add these splice points.

FIGS. 7(A) and 7(B) shows how start and end transition markers for ads can be inserted into PAD/XPAD fields of each audio packet. These splice points specify at which audio packet ads either begins or ends.

FIG. 11(A) shows how the start and end transition markers for ads are inserted into extended header 506. The markers are pointers to the audio frames in the current PDU in which ads either begin or end, as illustrated.

Alternate ads received out-of-band are cached in memory of the receiver along with the information received from Table of Contents. Out-of-band ads may come in multiple segments and, in such embodiments, the receiver needs to reassemble them before saving in memory (also referred to as cache). When a cached ad of the same duration is deemed to be more relevant and interesting to user than the ad that is received in-band, the in-band ad will be replaced with the ad from memory.

Therefore, to accomplish ad insertion, the first step is for the receiver 133 to receive a broadcast which includes the ads to be spliced out and to determine a transition point in the program stream when the ad to be spliced out is starting. The second step is to receive and store in memory alternate advertisements that are used to do the substitution. The alternate advertisement is can be transmitted out of band. The receiver 133 also receives metadata with each ad stored in memory which indicates the subject of the ad, its duration and, in some embodiments, its language. In some embodiments, the metadata transmitted with each ad also includes the location of stores which sell the product or service which is the subject of the ad. The next step is for the broadcast receiver to receive and store Table of Contents data transmitted either as metadata or in the program stream. The Table of Contents includes, in most embodiments, data about the subject of each ad, its time of broadcast and its duration. In some embodiments, it also includes the language of the ad. In some embodiments, the Table of Contents data also includes the location of stores selling the product and/or service which is the subject of the ad. If ad insertion at the host device is to be based upon either user preferences or user and host device current location, the client application 192 performs data mining processes before the substitution is to occur or accesses its store of metric data gleaned from data mining processes previously performed. Finally, the client application 192 uses the Table of Contents data and time of day data from the clock 191 to determine when an ad to be spliced out is about to occur. The client application then searches for a transition marker or detected transition in the metadata indicating an ad to be spliced out is starting. Once the splice point is found, the client application uses metrics data previously gathered to select an ad having a subject likely to be of more interest to the user of the host device and having the same duration as the ad to be spliced out. This ad is then selected and retrieved from memory by the client application 192 and its video and/or audio and/or image data is presented to the receiver for viewing and/or playback starting at the time the ad to be spliced out is starting. The receiver thus plays the substituted ad for the ad being spliced out. This is useful in many contexts especially where the user does not speak the language of the ad to be spliced out and the same ad in his language is spliced in.

### Data Mining

There is a wealth of data that is available to the client application to better target advertisements that are more likely to be of interest to the end user. For example, a user may have just done a search on his phone browser for a car. The client application then knows the end user might be in the market for a car. Likewise, the user's location can be used as one of the parameters. Location data can be obtained by the client application 192 in FIG. 4 by obtaining location data on line 125 from a GPS receiver 127 in FIG. 3 or from triangulation done by cell phone software in a known manner using signals from multiple cell towers, WiFi, Radio or TV stations. The GPS receiver 127 can be part of the broadcast receiver 133 which is added to the host device 123 in FIG. 3, or it can be an on board GPS receiver such as in found in many newer cell phones or it can determine its location using triangulation SW or HW. When the client application 192 running on the host device needs location data to do ad insertion or to generate turn by turn directions, it make a function call to the location function 189 in FIG. 3. The location function is a DLL or other program or subroutine which determines the location of the host device 123. The location can be determined from a GPS receiver on board the host device, a GPS receiver 127 added to the host device with the addition of the broadcast receiver 133 or by performing a triangulation calculation using signals from the sources listed above. The client application 192 has the capability in some embodiments using ad insertion based upon geographic location of the host device and geographic location of the nearest store which is selling the product or service of an advertisement that was clicked upon to generate a turn by turn list of directions for the user of the host device to guide him from the current location to the location of the nearest store, or, in some embodiments, to display a map showing the user's location and the location of the nearest store. In some embodiments, the client application can generate the turn by turn directions by launching an internet request to Google Maps™ or some other similar service which can provide turn by turn driving directions given a starting address and an ending address. In such embodiments, the client application 192 launches an internet request for turn by turn directions by sending a URL for the mapping service to the API of the web browsing function 196, and passing it the host device's current location and the location of the nearest store as arguments. The web browsing function 196 then makes an API request to the mapping service to request turn by turn directions from the starting location to the ending location. The ending location is the store address retrieved from the metadata of the ad the user clicked upon or just the metadata of an ad which is broadcast at the time a user happens to be in the vicinity of a store or promotion point which is the subject of the ad. The mapping service returns the turn by turn directions as a web page. This returned turn by turn list of directions is displayed as a web page to the user of the host device or relayed through text to speech.

Other parameters that can be used for ad insertion, are the demographics which can be obtained when the owner registers the device such as the average income of the people in the zip code the user gives for his address. In case of cell phones, the service providers have a lot of information about the end users since the user has provided this information as a part of the service contract. This is also true of other subscription based services such as for cable TV or satellite TV as well.

In the case of smart phones there is a wealth of information available based on the user's internet usage that can be used to enhance advertisement targeting, i.e., insertion of targeted ads by the client application at the client device based upon information the client application has gathered about the user in any way. In the case of devices with an embedded GPS, searches could also be used to target advertisements such as inserting ads for restaurants, stores, attractions, etc. in the vicinity of the user. The use of GPS searches to target advertisements is very applicable to Personal Navigation Devices (PNDs). Also information such as viewing and listening patterns can be used to determine user's interests.

In another exemplary scheme, the client application can be made self learning in that it could learn information about the user as time goes by and use this information to better target advertisements.

Alternatively all the data mining can be done on a centralized data mining server based upon information sent up by the client application or by any other means. The centralized data mining server would then download information to the device useful for ad insertion of targeted ads. This information could be download to the device either via the unicast internet or broadcast in such a manner that only intended receiver or group of receivers get the information.

### Augmenting Ads With Location Data

In addition to providing mechanisms to connect user to advertisers phone or web store fronts, the augmented metadata can be extended to contain location information for the advertiser's physical store or promotional spot. When receiving this information, it is possible to provide a map to the store location using the mapping applications that are available on most smart phones by having the client application make a function call to the mapping application API and passing it the address from the metadata. Most if not all the Android's based smart phones and Android operating system based devices support the Google MAP™ API and Map Kit™ API.

A further enhancement can be achieved if the host device has GPS or the broadcast receiver added to the host device has a GPS 127 or the host device is a cell phone with a location function 189 (FIG. 4) which can determine the location of the phone by triangulation of signals or by similar processes such as “assisted GPS”. A current approximate or exact location of the host device can be obtained from one of these sources can be used to locate the device on the map relative to the store. When the seller's location(s) information is used in conjunction with the device's location, specific driving directions can be provided. Location information can also be helpful when multiple stores exist and the user's current location is used to provide the user with the closest store.

In some embodiments, the client application 192 has the capability to search the internet for store locations of stores that sell the product or service which is the subject of an ad. In such applications, the client application makes a function call to the API of the web browsing software 196 of the host device and requests that it contact a search engine server and passes the search term(s) as an argument(s). The returned search results are then passed back up to the client application which examines them and determines the locations of stores that sell the product or service or the nearest store that sells it in some embodiments. The client application may then launch other internet service requests to other servers on the internet to obtain turn by turn directions to the nearest store or display a map showing the nearest store or all stores and the current location of the host device.

### Time Slicing

Timeslicing is a common technique that is used for low power receivers. If the amount of data that needs to be cached on the receiver is less than the maximum that can be transmitted on the pipe, then it is possible to timeslice and reduces the on time of the receiver thereby reducing the power consumption. The concept of time slicing can be applied to broadcast pipe when the pipe is used for transmitting OOB advertisements.

In one exemplary embodiment, the time slicing could be done using a Table Of Contents that is periodically transmitted as either in band metadata or out of band metadata (usually OOB) which indicates when a certain advertisement will appear, or the subjects of ads and when they will appear and their durations, or when certain broadcasts will occur and the subjects thereof and their durations. The receiver will then only wakeup for periods when it needs to be up to fetch the content based upon the information in the Table of Contents. The Table of Contents is also broadcast for ad insertion at the client device (also called the host device herein). The Table of Contents, in one embodiment, includes data about when an ad or (broadcast segment) will start, its subject and its duration. The advertisement code can be constructed in any way. For example, a list of all possible subjects or products or services can be generated, and each subject type, product or service can be given its own unique code. The client device receives the list of subjects and codes and stores it in memory and uses the subject data in the Table of Contents broadcast in the metadata to look up the subject of each ad or broadcast segment and turn on the receiver to receive only the ad or broadcast segment of interest. In other embodiments, the Table of Contents contains a unique advertising code for each ad, and when it will be broadcast. The client application 192 reads the advertising code for each ad and infers data about the advertisement from the ad code and uses the inferred data and time of broadcast to determine when to wake up the host device 123 and the broadcast receiver 133.

The client application 192 in FIG. 4 wakes up the host device by either monitoring a clock 191 or from timing derived from the receiver clock recovery circuitry (please refer to Ref 8 and Ref 9 for more details) and sends a command to a wakeup circuit shown at 201 in FIGS. 3 and 4 when an ad or program that needs to be received and played or stored is about to be broadcast. The wakeup circuit 201 controls a power control circuit 203 in FIGS. 3 and 4 to allow power to reach the appropriate circuits of the host device 123 and its broadcast receiver 133 and to cause both the host device and the broadcast receiver to wake up and start receiving broadcast program stream content and auxiliary metadata transmitter either in band or out of band. In some embodiments using timeslicing, the broadcast receiver 133 has its own clock and microprocessor which are never powered down. In other embodiments, the clock and microprocessor of the host device and portions of the receiver are never powered down and the client application 192 running on the host device microprocessor continually monitors the host device clock and Table of Contents data in memory and data indicating which programs and/or advertisements listed in said Table of Contents are to be received, and when the broadcast time for the ad or program arrives, the client application 192 sends the wakeup command to wake up the rest of the circuits not already awake. In embodiments where the client application 192 runs on a microprocessor in the broadcast receiver 133 and uses a clock in the broadcast receiver (not shown), the microprocessor of the host is powered and the receiver periodically wakes up and then wakes up the host processor.

In another exemplary embodiment of timeslicing, there is a priority schedule that the transmitter and receiver are familiar with. In such embodiments, the client application 192 monitors the priority schedule and a clock 191 in FIG. 4 and sends the command to the wakeup circuit 201 There a number of other ways of transmitting advertisements to low power devices in such a way so that timeslicing can be performed as will be apparent to those skilled in the art.

Assuming that a pipe of bandwidth 12 Kbps is used to deliver advertisements out of band. This pipe bandwidth means that during a 24 hour time period, the pipe can used to deliver 1.296 Gbits of advertising metadata. Assuming that the data is repeated thrice for robustness, this still leaves a pipe of 345.6 Mbits i.e. 43.2 MB. At 48 Kbps audio streams (AAC v2 as an example) can be 7200 seconds in duration. This means that 2 hours of audio content can be cached on the client device over such a pipe. Assuming that advertisements are sent as images with a resolution of 200×200 in PNG format with a size of approximately 12.5 KB/image, then 3456 images can be transferred and cached on the device.

In one exemplary embodiment, data is transmitted as small segments to reduce the probability of packet errors. The Table of Contents or schedule indicates not only when certain packets are transmitted but also when the segments associated with a packet are transmitted. Hence under ideal reception conditions where are all the segments are received without any errors, the receiver can be asleep 67% of the time.

It is also possible to do timeslicing without the need to transmit apriori a table of advertisements and when they are broadcast. In one exemplary way of timeslicing on an IBOC system, the layer 1 (L1) frame is associated to an advertisement code like the AD-ID prefix (ISCI Prefix) such as in shown in FIG. 12. For both timeslicing and ad insertion, the subject matter of the advertisement is needed. The receivers will only be awake on L1 frames that carry the advertisements that are of interest to the device, as indicated by the AD-IDs like that shown in FIG. 12 that are transmitted in a table that associates each L1 frame with a unique AD-ID. The association can be transmitted in any other way also so long as the receiver can determine which frames to awaken to receive so that the ads of interest are received and cached.

There are many ways the unique code in the AD-ID code structure can be used to achieve the association with a L1 Frame. These targeted advertisements would then each be only picked up by a small subset of the receivers.

In a simple pedantic example, one of the bytes (characters in the AD-ID code) can be used to subdivide the advertisements into 256 different categories. In a very simplistic scheme in a IBOC system, these advertisements would then be sent in 256 different L1 frames and the receiver that is only interested in one category of advertisements would be powered up for one of the 256 frames. In the case of 50 mW receiver, the power consumption of the receiver can be reduced to 195.3 uW.

There are numerous ways of using the AD-ID code to do geographic targeting (send a code which indicates which geographic area the advertisement is targeted for). Based on the position of the receiver determined by GPS or by triangulation, the receiver will only turn on to receive advertisements that are relevant based on its location. Obviously multiple fields with different information can be used to do more targeting. It should be obvious to somebody skilled in the art that it is possible to uses the advertisement code to indicate the nature of the advertisement and the targeted audience. The receiver can then choose to only receive a subset of the advertisements.

There are multiple ways of using advertisement codes or subject matter codes of any kind to implement timeslicing on the receiver for a number of different digital broadcast standards or AM or FM analog broadcast standards, and any manner of transmitting the Table of Contents downstream in the broadcast data or the metadata will suffice to practice the invention.

One embodiment of implementing time slicing is receiving Table of Content data broadcast downstream in metadata which indicates at least which advertisements and broadcast programs are going to be broadcast and when they are going to be broadcast and the subject of each advertisement or broadcast program. Then either using data gathered by said device about the preferences and interests of the user of said device or using commands from said user in response to display of said Table of Contents data, the device selects advertisements or broadcast programs having subjects of interest to the user of said device and wakes up the device from a power saving mode only at times said device needs to be on and receiving broadcasts and metadata in order to receive selected broadcasts and/or advertisements. An improvement on this basic embodiment includes the step of storing said selected broadcasts and/or advertisements in memory of said device for later playback. Upstream click event data is sent based upon the advertisements and/or broadcast programs the user of said device chose to view or playback.

Another embodiment loosely based upon timeslicing comprises receiving Table of Content data broadcast downstream in metadata which indicates at least which advertisements and broadcast programs including podcasts are going to be broadcast and when they are going to be broadcast and the subject of each advertisement or broadcast program. Then, either using data gathered by said device about the preferences and interests of the user of said device or using commands from said user in response to display of said Table of Contents data, selecting advertisements or programs having subjects that may be of interest to the user of said device and speculatively receiving and storing in memory of said device for later playback broadcast programs or ads which may be of interest to said user. Then, the device displays a list of broadcast programs and advertisements which are stored in memory and available for playback, and, if the user chooses to view and/or playback any stored broadcast program or advertisement, sending a click event upstream indicating interest in the ad or broadcast program.

### Ad Delivery Networks

An advertising network or ad network is a company that connects web sites that want to host advertisements with advertisers who want to run advertisements. FIG. 13 is a diagram of a system in which an advertising network server does its work to send ads for broadcast to Radio/TV broadcast equipment via the internet.

In one exemplary embodiment, the Radio/TV Broadcast equipment 100 in FIG. 13 looks like an Ad Serving client to the Advertisement Server 105. Instead of placing the advertisement in a website like a traditional Ad serving client, here the advertisements are delivered over the internet 111 to the Radio/TV Broadcast Equipment 100 for broadcast over the Radio/TV infrastructure either inband or out of band. The broadcast equipment (broadcast server 100) would communicate with the advertisement server over the internet 111 similar to a tradition Ad Serving client.

In one exemplary embodiment, the broadcast server 100 would aggregate the profile of the listeners/viewers in a certain area and report to the advertisement server 105. The broadcast server could also terminate return connections such as ad click communications and collected profile data about the users from the receivers in the field. The return path could be via a plurality of methods such as SMS or the internet (either directly over a cellular or WiFi network or cached on the device and transmitted over the internet when in a WiFi Hostspot or via a PC when the device is docked). Hence this Ad Serving Client could be made to look like a traditional ad serving client.

### Security Issues

Click Fraud is a common problem with pay per click advertising. This is one of the advantages of the broadcast delivery model. Since this is a closed system it is much more secure than the traditional ad serving client. There are a plurality of authentication methods that can be used to secure the communication between the device and the Advertisement Server or the broadcast equipment masquerading as an Ad Serving client or any other entity that is responsible for terminating the ad click and/or profile data return path. These prior art methods can be used for authenticating devices and verifying click notification. The security methods are well known to the people skilled in the art, and won't be further described here. Any one of these authentication methods will work. As an example each of the receivers could be made to have a unique key or private/public key pair, and their upstream communications can be encrypted with their private key and descrypted with their public key in the way Pretty Good Privacy and other public/private key encryption systems work.

In the out of band advertisement delivery paradigm as well as with the advertisement insertion, the fact that the impression occurred also needs to be communicated back. Similar authentication and verification mechanisms can be used here as well.

### Advertisement Monitoring

Advertisers are very interested in monitoring and verifying if an advertisement spot that they purchased was actually broadcast. The advertisers typically get charged whenever the advertisement is broadcast over the air. Also the advertiser would like to know how many people listened or viewed an advertisement. This is currently done by the use of statistical estimation techniques. This can be extended to the case where copyrighted content is broadcast then the royalty holders need to get compensated.

Currently there are a number of mechanisms that are used to verify that an advertisement was played over the air such as audio watermarking.

Application of the teachings of the inventions disclosed herein can be used for ad monitoring or royalty monitoring in several ways. In one embodiment, metadata is broadcast either in band or out of band with a unique ad ID or special codes when copyrighted content or an ad is being played/viewed on the host device. The client application keeps a record of these unique ad IDs for all ads played on the host device and/or keeps a record of all unique royalty monitoring codes for royalty bearing broadcast programs such as song which are played on the host device. The records maintained by the client application of the ad IDs and/or royalty monitoring codes for ads and/or royalty bearing works played on the host device can be used instead of audio watermarking techniques to do ad monitoring in some embodiments. The upstream return path can be used by the client application to send its stored records or ad IDs or royalty monitoring codes or to otherwise send an indication upstream whenever an advertisement or a particular content is broadcast. These records or other indications are sent by the client application 192 to whatever entity accumulates such data for compensation purposes which then compensates the appropriate party such as the broadcaster for broadcasting the work or ad. In other embodiments, the transmitters include circuits to maintain records of ad IDs for ads which have been transmitted and/or royalty monitoring codes of royalty bearing works which have been transmitted. Preferably, the return path via the internet or SMS data path is used by the client application to indicate that the advertisement actually reached the viewer or listener using the host device. These clicks to indicate that an advertisement reached the eyeball or the ear are a much more accurate measure of advertisement reach, so compensation may be justifiably higher. The existing statistical model can be enhanced to cover the non connected devices. The techniques described above can be extended to Analog FM with RDS where the metadata is transmitted over RDS. Also since sophisticated signal processing capabilities exist in the baseband, the audio watermarking techniques can be detected in the baseband and used to send back click events that the advertisement was listened to.

### Content-Centric User Interface for IBOC Radios

Existing user-interface for IBOC/FM radios allow users to browse through frequencies to access content from different radio stations. As metadata information about the radio station (station logo, slogan, service information) and its contents (program type etc) are available at the receiver for each radio station for IBOC receivers, a new radio-user-interface can be designed which will allow users to browse through the contents based on the content type rather than frequencies. Users need not remember the frequencies, rather they would access contents based on its type. This is very similar to the service-based interface in DAB radios where the frequency information is hidden from the user. Also on DAB and IBOC, it is possible to display what is currently playing on different stations. In the case of a dual tuner application the update can happen frequently because the secondary tuner can be utilized to do this scan while the primary tuner is used for playing audio. In a single tuner solution the scan for what's playing is initiated when the user is not listening to the radio.
The first thing, the radio will do after powering on is to scan through all the available frequencies and generate the list of all the available content for the user to browse through.
Information from RDS channel can be used for stations which are not HD. Frequency information can be used as a last resort for stations which do not support IBOC or RDS.

When supporting IBOC radio on mobile devices with internet access, user experience can be enriched by displaying information about the radio stations and content downloaded off the internet or precached data,

The following references are hereby incorporated by reference:
[Ref 1] ETSI EN 300 401 “Radio Broadcasting Systems: Digital Audio Broadcasting (DAB) to mobile, portable and fixed receivers”, May 2001
[Ref 2] Digital Audio Broadcasting, Principles and Applications of DAB, DAB+ and DMB 3^{rd} Edition, by Wolfgang Hoeg and Thomas Lauterbach, John Wiley, 2009
[Ref 3] Multimedia Object transfer Protocol (EN 301-234)
[Ref 4] SY_IDD_{—}1011s—HD Radio Air Interface Description—Layer 1 FM
[Ref 5] SY_IDD_{—}1012s—HD Radio Air Interface Description—Layer 2 Channel Mux
[Ref 6] SY_IDD_{—}1017s—HD Radio Air Interface Description—Audio Transport
[Ref 7] IBOC Handbook—Understanding HD Radio Technology by David P. Maxson
[Ref 8] U.S. Pat. No. 7,742,458—Low power digital media broadcast receiver with time division—Sridhar Sharma and Oren Arad
[Ref 9] USPTO Patent application # 20080291857—Timeslot scheduling in digital audio and hybrid audio—Oren Arad, Sridhar Sharma, Shay Waxman and David Bydeley

Although the inventions have been disclosed in terms of the preferred and alternative embodiments disclosed herein, those skilled in the art will appreciate that modifications and improvements may be made without departing from the scope of the invention. All such modifications are intended to be included within the scope of the claims appended hereto.

What is claimed is:

1. In a system comprising a category 1, 2, 3 or 4 host device having a microprocessor, memory, user interface controls, display and audio circuitry to playback video and audio program data and metadata to a user of said host device and having “circuitry” comprising any combination of hardware, software and/or firmware to control said host device and having circuitry and software for making bidirectional digital communications over the internet or a Short Message Service (hereafter SMS) data path either directly or through a 3G cellular system data path or through a wifi hot spot or indirectly through a computer or other device to which said host device is docked and which has an internet connection, the improvement comprising:
a receiver in or coupled to said host device that has circuitry that functions to receive auxiliary metadata broadcast in band or out of band with a primary media program broadcast using any of the following standards: FM+RBDS/RDS or IBOC or DAB or ATSC, or Mobile ATSC or DVB or any data broadcast protocol or standard developed in the future which allows metadata to be broadcast either in band or out of band or both along with digital or analog primary media programming, said receiver system also having circuitry which functions to provide said received primary media program and said received metadata to said host device for display and/or playback and which can control said host device to make upstream communications over the internet or said SMS data path;
and wherein the term “circuitry” used anywhere in this claim or its dependent claims means any combination of hardware circuits, software and/or firmware controlling hardware circuits, the combination being able to perform the stated function(s).

2. The system of claim 1 wherein said auxiliary metadata includes advertisements, and wherein said receiver has circuitry which functions to detect ad click events and communicate them upstream over the direct or indirect connection to said internet of said host device or said SMS data path to a collection entity that aggregates click events and collects compensation for said click events for the broadcaster or cell phone operator or any other entity to which compensation is due for causing said advertisement to be transmitted to a user of said host device who viewed or listened to said advertisement and expressed interest in any way using said host device.

3. The system of claim 1 wherein said host device is a category 2 device which only has a connection to the internet when said host device is in a wifi hot spot, where wifi hotspot means a transceiver which transmits and receives bidirectionally using any of the IEEE 802.11 standards such as 802.11g.

4. The system of claim 2 wherein said host device is a category 3 device which only has a connection to the internet when it is docked with or coupled to a computer or other device which has a connection to the internet, and wherein said receiver includes circuitry to send an ad click event upstream to said collection entity by sending said ad click event first to said host device for transmission to said computer or other device to which said host device is docked for subsequent transmission to said collection entity by said computer or other device to which said host device is docked.

5. The system of claim 2 wherein said host device is a category 4 device which only can transmit digital data via an SMS upstream data path through a cellular system provider, and wherein said receiver has circuitry to transmit ad click events to said collection entity through said SMS data path.

6. The system of claim 2 wherein said receiver has circuitry to store advertisements received in either said in band or out of band auxiliary metadata in memory of said host device or memory of said receiver for later retrieval for display or playback, where memory means any type of volatile or non volatile type of memory including a hard disk, RAM, or FLASH memory (EPROM or EEPROM).

7. The system of claim 2 wherein said receiver has circuitry to store advertisements received in either said in band or out of band auxiliary metadata in memory of said host device or memory of said receiver for later retrieval for display or playback, where memory means any type of volatile or non volatile type of memory including a hard disk, RAM, or FLASH memory (EPROM or EEPROM), and wherein said receiver further comprises circuitry to detect transitions in metadata or transition markers transmitted with said auxiliary metadata to mark splice points and circuitry to splice in an advertisement retrieved from memory which has the same duration as an advertisement received in said metadata which is to be replaced.

8. The system of claim 2 wherein said receiver has circuitry to share advertisements and associated metadata received in said auxiliary metadata on social networking sites including Facebook™ and Twitter™ by making one or more function calls to the application programmatic interface of the software executing said social networking sites on one or more servers, and passing the advertisement and associated metadata with said function call(s).

9. The system of claim 2 wherein said receiver includes circuitry to receive advertisements transmitted out of band with a broadcast even when a user of said host device is not viewing or listening to a broadcast and store said advertisement(s) in memory of said host device or said receiver, and to recall said advertisements later from memory and display them or play them back to a user of said host device as said user is doing something else on said host device.

10. The system of claim 2 wherein said primary media program is a digital data stream (hereafter the “program stream”) which includes transition markers or splice point data in said program stream marking the beginning of advertisements broadcast in said program stream, and wherein said receiver includes circuitry to receive advertisements transmitted as either in band or out of band metadata along with metadata indicating the subject and duration of each advertisement received as metadata, and for storing said advertisements received as metadata and metadata indicating the subject and duration of each advertisement received as metadata in memory, and wherein said receiver includes circuitry to receive Table of Contents data transmitted either as metadata or in said program stream which indicates the subject and duration and time of broadcast of each advertisement which is going to be broadcast in said program stream, and wherein said receiver includes circuitry to gather metrics about the preferences and interests of a user of said host device learned by any data mining technique such as web searches performed from said host device or from subscription data of subscriptions maintained by said user, and wherein said receiver includes circuitry to use said Table of Content data to determine when an advertisement to be replaced at said receiver with an advertisement retrieved from memory is to be broadcast, and search for transition markers or splice points in said program stream indicating when said advertisement to be replaced is starting in said program stream and to use said metrics data and said metadata stored in memory indicating the subject and duration of advertisements stored in memory to select an advertisement stored in memory which is likely to be of more interest to said user of said host device and which has the same duration and to retrieve the selected advertisement from memory and send it to the host device for display and/or playback in place of the advertisement to be replaced that is arriving in said program stream.

11. The system of claim 10 wherein said receiver includes circuitry to gather said metric data by performing any combination of one or more of the following data mining processes: monitoring searches of the internet performed by the user of said host device; monitoring location of the user and host device at various times; monitoring which broadcasts are viewed and/or listened to by the user of said host device; and/or monitoring which songs, products, videos and/or services are purchased by said user using said host device.

12. The system of claim 2 wherein said primary media program is a digital data stream (hereafter the “program stream”) which includes transition markers or splice point data in said program stream marking the beginning of advertisements broadcast in said program stream, and wherein said receiver includes circuitry to receive advertisements transmitted as either in band or out of band metadata along with metadata indicating the subject, language and duration of each advertisement received as metadata, and for storing said advertisements received as metadata and metadata indicating the subject, language and duration of each advertisement received as metadata in memory, said advertisements received either as in band metadata or out of band metadata being the same advertisements as are broadcast in said program stream but in different languages, and wherein said receiver includes circuitry to receive Table of Contents data transmitted either as metadata or in said program stream which indicates the subject, language and duration and time of broadcast of each advertisement which is going to be broadcast in said program stream, and wherein said receiver includes circuitry to gather metrics about the native language of a user of said host device learned by any data mining technique such as web searches performed from said host device or from subscription data of subscriptions maintained by said user, and wherein said receiver includes circuitry to use said Table of Content data to determine when an advertisement to be replaced at said receiver with an advertisement retrieved from memory is to be broadcast, and search for transition markers or splice points in said program stream indicating when said advertisement to be replaced is starting in said program stream and to use said metrics data and said metadata stored in memory indicating the subject, language and duration of advertisements stored in memory to select an advertisement stored in memory which is in the native language said user of said host device and which has the same duration and to retrieve the selected advertisement from memory and send it to the host device for display and/or playback in place of the advertisement to be replaced that is arriving in said program stream.

13. The system of claim 2 wherein said primary media program is a digital data stream (hereafter the “program stream”) which includes transition markers or splice point data in said program stream marking the beginning of advertisements broadcast in said program stream, and wherein said receiver includes circuitry to receive advertisements transmitted as either in band or out of band metadata along with metadata indicating the subject, location of stores selling the product or service which is the subject of the advertisements received as in band or out of band metadata and duration of each advertisement received as metadata, and for storing said advertisements received as metadata and metadata indicating the subject, language and duration of each advertisement received as metadata in memory, and wherein said receiver includes circuitry to receive Table of Contents data transmitted either as metadata or in said program stream which indicates the subject and duration and time of broadcast of each advertisement which is going to be broadcast in said program stream, and wherein said receiver includes circuitry to gather metrics about the preferences and/or interests and current location of a user of said host device learned by any data mining technique such as web searches performed from said host device or from subscription data of subscriptions maintained by said user and from position data of said user and said host device gathered from an on board GPS receiver or by triangulation using cell towers, and wherein said receiver includes circuitry to use said Table of Content data to determine when an advertisement to be replaced at said receiver with an advertisement retrieved from memory is to be broadcast, and search for transition markers or splice points in said program stream indicating when said advertisement to be replaced is starting in said program stream and to use said metrics data including the current location of said user and said host device and using said metadata stored in memory indicating the subject, location of stores selling the product or service which is the subject of the advertisement to be retrieved from memory and used to replace an advertisement being broadcast in said program stream and duration of advertisements stored in memory to select an advertisement stored in memory for a product or service which is sold at a store near the current location of said user and said host device and which has the same duration and to retrieve the selected advertisement from memory and send it to the host device for display and/or playback in place of the advertisement to be replaced that is arriving in said program stream.

14. The system of claim 2 wherein said receiver includes power savings mode circuitry to shut down power consumption by said receiver and said host device and to only wake up said receiver and said host device during predetermined time windows to receive auxiliary metadata broadcast in band and/or out of band and either display and playback said auxiliary metadata or store said received auxiliary metadata in memory.

15. The system of claim 14 wherein Table of Contents data is broadcast in said program stream and/or said metadata, said Table of Contents data including data on the subject, time and duration of programs to be broadcast in said program stream and/or said auxiliary metadata, and wherein said receiver includes circuitry to receive said Table of Contents data and use said data to determine when to wake up said receiver and host device.

16. The system of claim 14 wherein Table of Contents data is broadcast in said program stream and/or said metadata, said Table of Contents data including data on the subject, time and duration of advertisements to be broadcast in said program stream and/or said auxiliary metadata, and wherein said receiver includes circuitry to receive said Table of Contents data and use said data to determine when to wake up said receiver and host device.

17. The system of claim 14 wherein Table of Contents data is broadcast in said program stream and/or said metadata, said Table of Contents data including a unique advertising code for each advertisements to be broadcast either in said program stream or said auxiliary metadata, and wherein said receiver includes circuitry to receive said Table of Contents data and use the unique advertising code for an advertisement to infer data about the advertisement such as the product or service which is the subject of said advertisement and/or the location of stores selling the product or service which is the subject of said advertisement and to use said inferred data to determine when to wake up said receiver and host device.

18. The system of claim 2 wherein said auxiliary metadata includes data about the physical location of stores or promotional spot specified in an advertisement which a user of said host device clicked upon, and wherein said receiver includes circuitry which uses said metadata about the location of said store and the physical location of said host device to generate a list of turn by turn directions to said physical location of said store from the host device's current position.

19. The system of claim 2 wherein said receiver includes circuitry to use auxiliary metadata of an advertisement to perform a search of the internet to find locations of stores which sell the product or service which is the subject of said advertisement and use the current location of said host device and said location information obtained from said search to generate and display a list or turn by turn directions from the current location of said host device to the location of the nearest store.

20. The system of claim 2 wherein said received metadata includes a unique ad code for every advertisement received by said receiver in said metadata, and wherein said receiver included circuitry to keep a record of each said unique ad code for an advertisement which was received, and for sending said record data upstream over an internet or SMS data path of said host device to an entity which performs an ad monitoring service.

21. The system of claim 2 wherein said received metadata includes a unique ad code for every advertisement received by said receiver in said metadata, and wherein said receiver included circuitry to detect which advertisements were viewed and/or listened to by a user of said host device and keep a record of each said unique ad code for an advertisement which was viewed and/or listened to by said user, and for sending said record of advertisements that were viewed and/or listened to upstream over an internet or SMS data path of said host device to an entity which determines compensation to broadcasters for advertisements that were viewed and/or listened to.

22. A transmitter for transmitting a broadcast program stream according to a predetermined standard, the improvement comprising:
circuitry to transmit auxiliary digital metadata with said broadcast program stream;
and wherein the term circuitry as used in this claim and its dependent claims includes any combination of hardware circuits, software or firmware which can perform the stated function.

23. The apparatus of claim 22 wherein said predetermined standard is one of the following: FM+RBDMS; IBOC; DAB; ATSC; Mobile ATSC, DVB or some other data broadcast scheme to be developed in the future.

24. The apparatus of claim 23 wherein said transmitter includes circuitry to broadcast said metadata either in band or out of band, and wherein in band means said metadata is transmitted in the same subchannel as said broadcast program stream, and out of band means said metadata is transmitted in another subchannel other than the subchannel in which said broadcast program stream is broadcast.

25. The apparatus of claim 23 wherein said transmitter includes circuitry to transmit said metadata out of band and wherein said transmitter further comprising circuitry to transmit Table of Contents data which includes the subject and duration and broadcast time of advertisements and to broadcast transition markers which mark at least the beginning of each advertisement.

26. The apparatus of claim 23 wherein said transmitter includes circuitry to transmit start and end transition markers which mark the start and end of advertisements and/or programs which are transmitted in band and/or out of band.

27. The apparatus of claim 23 wherein said transmitter includes circuitry to transmit Table of Contents data downstream which includes data indicating when advertisements are going to be broadcast and the subject and duration of each.

28. The apparatus of claim 23 wherein said transmitter includes circuitry to receive advertisements for insertion into said broadcast program stream from an ad server to which said transmitter is coupled via any data path.

29. The apparatus of claim 23 wherein said transmitter includes circuitry to receive advertisements from an ad server and transmit said ads as out of band metadata.

30. The apparatus of claim 23 wherein said metadata associated with an advertisement which is broadcast includes data about the location of stores selling the product or service which is the subject of said advertisement.

31. The apparatus of claim 23 wherein said transmitter includes means for transmitting data to receivers, said data being used by said receivers to determine when they need to turn on out of power savings mode.

32. The apparatus of claim 31 wherein transmitter includes circuitry for transmitting Table of Contents data to receivers, said Table of Contents data being used by receivers to determine when they need to turn on out of power savings mode.

33. The apparatus of claim 31 wherein said transmitter includes circuitry to transmit unique advertisement codes associated with each said advertisement which is broadcast, each said advertisement code for use by receivers of said broadcast advertisements to infer data about the advertisement with which said advertisement code is associated such as the subject of the ad, the location of a store selling the product or service which is the subject of said ad, said receivers using said advertisement codes to determine when to wake up out of power savings mode.

34. The apparatus of claim 23 wherein said transmitter includes circuitry to transmit unique advertisement codes associated with each said advertisement which is broadcast and circuitry to keep a record of the advertisement codes of each advertisement that was broadcast.

35. The system of claim 2 wherein said receiver has circuitry to share advertisements and associated metadata and audio and/or video clips received in said auxiliary metadata or said program stream and post them on social networking sites including Facebook™ and Twitter™ by making one or more function calls to the application programmatic interface of the software executing said social networking sites on one or more servers, and passing the advertisement and associated metadata and audio and/or video clip and a URL to which a click event should be sent as an argument with said function call(s), and further comprising a computer program executing on a server running said social networking site which detects clicks by users of said social networking site on any advertisement, audio and/or video clip posted on said site by said receiver and functioning to send a click event to the URL sent by said receiver with said posting.

36. A method of doing business comprising:
broadcasting a main program stream;
broadcasting auxiliary metadata with said main program stream either in band or out of band, said metadata including advertisements;
receiving said main program stream and said metadata in a host device and detecting click events and transmitting said click events upstream over an internet or SMS connection of said host device to an aggregator of click events; and
paying compensation to a broadcaster who broadcast an advertisement which was the subject of a click event.
